(19) United States
(12) Patent Application Publication
(10) Pub. No.: US 2023/0235202 A1
(43) Pub. Date: Jul. 27, 2023

(54) PLASTICIZER FOR RESINS

(71) Applicant: IDEMITSU KOSAN CO.,LTD., Chiyoda-ku (JP)

(72) Inventors: Kiyokazu KATAYAMA, Ichihara-shi (JP); Hideaki NODA, Ichihara-shi (JP); Michika TOKUNAGA, Ichihara-shi (JP); Shuhei ARITA, Ichihara-shi (JP); Nozomu FUJII, Ichihara-shi (JP)

(73) Assignee: IDEMITSU KOSAN CO.,LTD., Chiyoda-ku (JP)

(21) Appl. No.: 18/007,197

(22) PCT Filed: Jul. 6, 2021
(86) PCT No.: PCT/JP2021/025480

§ 371 Date: Jan. 27, 2023

(30) Foreign Application Priority Data
Jul. 31, 2020 (JP) 2020-130979
Jul. 31, 2020 (JP) 2020-130983

(51) Int. Cl. C09J 123/12; C08F 110/06; C09J 123/08; C09J 123/14; C09J 5/06

(52) U.S. Cl. CPC C09J 123/12; C08F 110/06; C09J 123/0815; C09J 123/142; C09J 5/06; C08L 2205/025; C08L 2205/03; C08L 2205/06; C09J 2423/10; C09J 2423/04

(57) ABSTRACT

A plasticizer may be suitable for resins and contain an amorphous propylenic polymer having a weight-average molecular weight (Mw), measured according to a GPC method, in a range of from 5,000 to 30,000 and having a molecular weight distribution (Mw/Mn) of 3.0 or less. The amorphous propylenic polymer may be a propylene homopolymer

### TECHNICAL FIELD

The present invention relates to a plasticizer for resins that contains an amorphous propylenic polymer.

### BACKGROUND ART

Heretofore, a pressure-sensitive adhesive and an adhesive that contain a thermoplastic resin as a substrate have been variously investigated, as they are inexpensive and excellent in safety.

A pressure-sensitive adhesive and an adhesive are composed of a base polymer of a thermoplastic resin and the like, a tackifier and the like, in the case where the adhesive is desired to be softened, an oil or a liquid polyisobutylene can be blended therein.

For example, PTL 1 discloses, for the purpose of improving processability, a hot-melt adhesive preparation containing an isotactic butene-1 polymer-metallocene composition having a bimodal composition that contains an isotactic butene-1 homopolymer or a butene-1-isotactic copolymer having a comonomer content of 5 mol % or less, and a butene-1 isotactic copolymer having a comonomer content of 6 mol % to 25 mol %, and a viscosity modifier.

PTL 2 discloses, for the purpose of improving melt flowability and adhesive strength, a hot-melt adhesive for woodwork that contains an olefinic polymer having a specific tensile elasticity and a specific glass transition temperature, and an olefinic polymer having a specific glass transition temperature in a specific ratio.

On the other hand, PTL 3 discloses, for the purpose of improving high-speed coatability and adhesiveness, a hot-melt adhesive containing a propylene homopolymer obtained by polymerization of propylene using a metallocene catalyst and having a melting point of 100° C. or lower, and an ethylenic copolymer.

### CITATION LIST

### Patent Literature

PTL 1: JP2019-523315A
PTL 2: JP2016-102162A
PTL 3: JP2013-64055A

### SUMMARY OF INVENTION

### Technical Problem

Regarding thermoplastic resins for use in hot-melt adhesives, some kind of thermoplastic resin itself may have a high viscosity in melt, and therefore hot-melt adhesives may be hard and may become poor in coatability. For the purpose of softening such hot-melt adhesives to improve coatability and adhesiveness thereof, heretofore an oil or a liquid polyisobutylene has been used. However, an oil could soften an adhesive, but when added too much, it may worsen other characteristics such as elongation characteristics, and accordingly, there remains a problem in that an oil cannot be added too much. On the other hand, the commercially-available amorphous polyolefin used in PTL 2 is defective in that it may increase the viscosity in melt too much and worsen coatability, and that a softening temperature is too high and the adhesive is hardened too much. Consequently, a plasticizer that can reduce the viscosity of a hot-melt adhesive and simultaneously can impart good elongation characteristics to the hot-melt adhesive is desired.

Given the situation, the present invention is to provide a plasticizer for resins capable of reducing the viscosity in melt and capable of imparting elongation characteristics.

### Solution to Problem

The present inventors have repeated assiduous studies for the purpose of solving the above-mentioned problems and, as a result, have found that a plasticizer for resins that contains a specific amorphous propylenic polymer can solve the problems, and have completed the present invention.

The present invention relates to the following plasticizer for resins.

[1] A plasticizer for resins, containing an amorphous propylenic polymer having a weight-average molecular weight (Mw), measured according to a GPC method, of 5,000 to 30,000 and having a molecular weight distribution (Mw/Mn) of 3.0 or less.

[2] The plasticizer for resins according to the above [1], wherein the amorphous propylenic polymer is a propylene homopolymer.

[3] The plasticizer for resins according to the above [1] or [2], wherein the amorphous propylenic polymer satisfies the following (a) and (b):

(a) the meso pentad fraction [mmmm], determined by ¹³C-nuclear magnetic resonance measurement, is less than 20 mol %, and the racemic pentad fraction [rrrr] is less than 25 mol %,

(b) the 1,3-bond fraction, determined by ¹³C-nuclear magnetic resonance measurement, is less than 0.3 mol %, and the 2,1-bond fraction is less than 0.3 mol %.

[4] The plasticizer for resins according to any one of the above [1] to [3], wherein the amorphous propylenic polymer satisfies the following (c) and (d):

(c) the glass transition temperature, measured with a differential scanning calorimeter (DSC), is −15° C. or higher,

(d) the melt viscosity at 190° C. is 1,000 mPa·s or less.

[5] The plasticizer for resins according to any one of the above [1] to [4], wherein the number of terminal unsaturated groups per one molecule of the amorphous propylenic polymer is less than 0.5.

[6] A method of reducing the viscosity in melt of a resin composition containing a thermoplastic resin and imparting elongation characteristics to the resin composition, using the plasticizer for resins of any one of the above [1] to [5].

[7] The method according to the above [6], wherein the thermoplastic resin is a polyolefinic resin.

[8] The method according to the above [6] or [7], wherein the content of the amorphous propylenic polymer in the resin composition is 5 to 95% by mass.

[9] The method according to any one of the above [6] to [8], wherein the resin composition further contains a tackifier.

A method of reducing the viscosity in melt of a hot-melt adhesive containing a thermoplastic resin and imparting elongation characteristics to the hot-melt adhesive, using the plasticizer for resins according to any one of the above [1] to [5].

[11] The method according to the above [10], wherein the thermoplastic resin is a polyolefinic resin.

[12] The method according to the above [10] or [11], wherein the content of the amorphous propylenic polymer in the hot-melt adhesive is 5 to 95% by mass.

[13] The method according to any one of the above [10] to [12], wherein the hot-melt adhesive further contains a tackifier.

[14] An amorphous propylenic polymer satisfying the following (1) to (9):

(1) the weight-average molecular weight (Mw) is 5,000 to 30,000,

(2) the molecular weight distribution (Mw/Mn) is 3.0 or less,

(3) the meso pentad fraction [mmmm] is less than 20 mol %,

(4) the racemic pentad fraction [rrrr] is less than 25 mol %,

(5) the 1,3-bond fraction is less than 0.3 mol %,

(6) the 2,1-bond fraction is less than 0.3 mol %,

(7) the glass transition temperature is −15° C. or higher,

(8) the melt viscosity at 190° C. is 1,000 mPa·s or less,

(9) the number of the terminal unsaturated groups per one molecule is less than 0.5.

Also the present description discloses the following resin composition.

[15] A resin composition containing:

an amorphous propylenic polymer (AA) having a weight-average molecular weight (Mw), measured according to a GPC method, of 5,000 to 30,000 and having a molecular weight distribution (Mw/Mn) of 3.0 or less, and

a polyolefinic polymer (BB) having a melting point of 20° C. or higher and 160° C. or lower and ΔH of 5 J/g or more and 100 J/g or less.

[16] The resin composition according to the above [15], wherein the amorphous propylenic polymer (AA) is a propylene homopolymer.

[17] The resin composition according to the above [15] or [16], wherein the amorphous propylenic polymer (AA) satisfies the following (a) and (b):

(a) the meso pentad fraction [mmmm], determined by ¹³C-nuclear magnetic resonance measurement, is less than 20 mol %, and the racemic pentad fraction [rrrr] is less than 25 mol %,

(b) the 1,3-bond fraction, determined by ¹³C-nuclear magnetic resonance measurement, is less than 0.3 mol %, and the 2,1-bond fraction is less than 0.3 mol %.

[18] The resin composition according to any one of the above [15] to [17], wherein the amorphous propylenic polymer (AA) satisfies the following (c) and (d):

(c) the glass transition temperature, measured with a differential scanning calorimeter (DSC), is −15° C. or higher,

(d) the melt viscosity at 190° C. is 1,000 mPa·s or less.

[19] The resin composition according to any one of the above [15] to [18], wherein the polyolefinic polymer (BB) is a propylenic polymer.

[20] The resin composition according to any one of the above [15] to [19], wherein the content of the amorphous propylenic polymer (AA) is 5 to 95% by mass, and the content of the polyolefinic polymer (BB) is 5 to 95% by mass.

[21] The resin composition according to any one of the above [15] to [20], wherein the melt viscosity at 190° C. of the resin composition is 5,000 mPa·s or less.

[22] The resin composition according to any one of the above [15] to [21], wherein the storage elastic modulus at 25° C. is 1 MPa or more and 200 MPa or less.

[23] The resin composition according to any one of the above [15] to [22], further containing a tackifier.

[24] A hot-melt adhesive using the resin composition according to any one of the above [15] to [23].

### Advantageous Effects of Invention

According to the present invention, there can be provided a plasticizer for resins capable of reducing the viscosity in melt and capable of imparting elongation characteristics.

### DESCRIPTION OF EMBODIMENTS

### [Plasticizer for Resins]

The plasticizer for resins of the present invention contains an amorphous propylenic polymer having a weight-average molecular weight (Mw), measured according to a GPC method, of 5,000 to 30,000 and having a molecular weight distribution (Mw/Mn) of 3.0 or less.

The content of the amorphous propylenic polymer in the plasticizer for resins of the present invention is, in the plasticizer for resins, preferably 80% by mass or more, more preferably 90% by mass or more, even more preferably 95% by mass or more, further more preferably 99% by mass or more, and is 100% by mass or less. The plasticizer for resins of the present invention may contain the amorphous propylenic polymer, or may be formed of the amorphous propylenic polymer alone.

### [Amorphous Propylenic Polymer and Amorphous Propylenic Polymer (AA)]

The amorphous propylenic polymer for use in the plasticizer for resins of the present invention has a weight-average molecular weight (Mw), measured according to a GPC method, of 5,000 to 30,000 and has a molecular weight distribution (Mw/Mn) of 3.0 or less.

The plasticizer for resins of the present invention may contain the amorphous propylenic polymer, that is, the amorphous propylenic polymer can be used as a plasticizer for resins, and has a weight-average molecular weight (Mw), measured according to a GPC method, of 5,000 to 30,000 and has a molecular weight distribution (Mw/Mn) of 3.0 or less.

The amorphous propylenic polymer (AA) for use in the resin composition to be mentioned hereinunder also has a weight-average molecular weight (Mw), measured according to a GPC method, of 5,000 to 30,000 and has a molecular weight distribution (Mw/Mn) of 3.0 or less.

Hereinunder the amorphous propylenic polymer for use in the plasticizer for resins of the present invention and the amorphous propylenic polymer (AA) for use in the resin composition to be mentioned below are described.

The amorphous propylenic polymer for use in the plasticizer for resins of the present invention and in the resin composition to be mentioned below (hereinafter simply referred to as the amorphous propylene polymer) can reduce the viscosity in melt and can impart elongation characteristics, and therefore by using the amorphous propylenic polymer as a plasticizer for resins, the viscosity in melt of a resin composition and a hot-melt adhesive can be reduced and elongation characteristics can be imparted thereto, and as a result, there can be provided a resin composition and a hot-melt adhesive excellent in coatability and adhesiveness.

The amorphous propylenic polymer is characterized in that it has a low VOC and is poorly odoriferous, differing from an oil and a liquid polyisobutylene generally used as a plasticizer. Further, the resin composition and the hot-melt adhesive using the amorphous propylenic polymer are also characterized in that they have a low VOC and are poorly odoriferous. In addition, the amorphous propylenic polymer has a higher glass transition temperature (Tg) than such an oil and a liquid polyisobutene, and can be therefore expected to attain an effect that the amount of a tackifier to be blended in a hot-melt adhesive containing the amorphous propylenic polymer can be reduced.

Further, when the amorphous propylenic polymer is mixed with a thermoplastic resin to give a resin composition, it can impart high adhesivity and transparency to the thermoplastic resin. Consequently, a resin composition containing the amorphous propylenic polymer and a thermoplastic resin has high adhesivity and transparency.

In the present invention, “amorphous” indicates a resin (polymer) which does not substantially show a crystal melting peak, that is, does not show a melting point in differential scanning calorimetry (DSC), since the crystallization speed thereof is extremely low or since it does not undergo crystallization at all. The amorphous propylenic polymer is preferably a resin (polymer) which does not show a crystal melting peak, or does not show a melting point, that is, which does not completely contain a crystal structure. In the case where a melting point is not shown, a melting enthalpy ΔH could not be substantially detected in many cases, and ΔH is less than 1 J/g. Namely, ΔH of the polymer is not shown or is less than 1 J/g.

The amorphous propylenic polymer has a weight-average molecular weight (Mw), measured according to a gel permeation chromatography (GPC) method, of 5,000 to 30,000, preferably 7,000 to 25,000, more preferably 9,000 to 20,000. When Mw is 5,000 or more, stickiness and VOC can be reduced. When Mw is 30,000 or less, and when used as a plasticizer, the viscosity in melt of the resin composition or the hot-melt adhesive can be reduced.

The amorphous propylenic polymer has a molecular weight distribution (Mw/Mn), measured according to a GPC method, of 3.0 or less, preferably 2.5 or less. When the molecular weight distribution (Mw/Mn) is 3.0 or less, and when used as a raw material for the resin composition or the hot-meld adhesive, the effect of reducing VOC is great. Also in the case of using singly as a plasticizer, VOC is low as compared with the case of using an oil or the like.

The weight-average molecular weight (Mw) and the number-average molecular weight (Mn) are both polystyrene-equivalent molecular weights, and specifically, can be measured and calculated using the following apparatus under the following conditions.

### <GPC Measurement Apparatus>

Device: “HLC8321GPC/HT” by Tosoh Corporation
Detector: RI detector
Column: “TOSOH GMHHR—H(S)HT” by Tosoh Corporation x 2

### <Measurement Conditions>

Solvent: 1,2,4-trichlorobenzene
Measurement Temperature: 145° C.
Flow Rate: 1.0 mL/min
Sample Concentration:0.5 mg/mL
Injection Amount: 300 μL
Calibration Curve: Prepared using a PS standard substance.
Molecular Amount Conversion: Calculated using a universal calibration method.
Analysis Program: 8321GPC-WS

Not specifically limited, the amorphous propylenic polymer is a polymer for which the main monomer is propylene, and is preferably a propylene homopolymer, or a propylene copolymer, more preferably a propylene homopolymer.

The propylene copolymer is preferably a copolymer of propylene and ethylene or an olefin having 4 to 12 carbon atoms, more preferably a polymer of propylene and ethylene or an α-olefin having 4 to 8 carbon atoms, even more preferably a copolymer of propylene and ethylene or 1-butene.

The amorphous propylenic polymer preferably satisfies the following (a) and (b):

(a) the meso pentad fraction [mmmm], determined by ¹³C-nuclear magnetic resonance measurement, is less than 20 mol %, and the racemic pentad fraction [rrrr] is less than 25 mol %,

(b) the 1,3-bond fraction, determined by ¹³C-nuclear magnetic resonance measurement, is less than 0.3 mol %, and the 2,1-bond fraction is less than 0.3 mol %.

In the present invention, the meso pentad fraction [mmmm] and the racemic pentad fraction [rrrr] are determined according to the method proposed by A. Zambelli, et al., in “Macromolecules, 6, 925 (1973)”, indicating the meso fraction as a pentad unit in the polypropylene molecular chain measured by the signal of the methyl group in a ¹³C-NMR (nuclear magnetic resonance) spectrum.

The above (a) and (b) can be determined by ¹³C-nuclear magnetic resonance measurement and are concretely determined by measurement using the following apparatus under the following conditions.

Apparatus: Model JNM-EX400, ¹³C-NMR Apparatus by JEOL Ltd.

Method: Proton Complete Decoupling Method

Concentration: 220 mg/mL

Solvent: Mixed solvent of 1,2,4-trichlorobenzene and heavy benzene, 90/10 (by volume)

Temperature: 130° C.

Pulse width: 45°

Pulse-recurrence time: 4 sec

Accumulation: 10,000 times

### <Calculation Formula>

[mmmm]=m/S×100

[rrrr]=y/S×100

S=Pββ+Pαβ+Pαγ

S: Signal intensity of side chain methyl carbon atom in all propylene units

Pββ: 19.8 to 22.5 ppm

Pαβ: 18.0 to 17.5 ppm

Pαγ: 17.5 to 17.1 ppm

y: Racemic pentad chain: 20.7 to 20.3 ppm

m: Meso pentad chain: 21.7 to 22.5 ppm

In the present invention, the 1,3-bond fraction, and the 2,1-bond fraction are determined in accordance with the methods proposed in “Polymer Journal, 16, 717 (1984)” reported by Asakura et al., in “Macromol. Chem. Phys., C29, 201 (1989)” reported by J. Randall et al., and in “Macromol. Chem. Phys., 198, 1257 (1997)” reported by V. Busico et al. That is, in the ¹³C-nuclear magnetic resonance spectrum, the signals for a methylene group and a methine group are read, and the 1,3-bond fraction, and the 2,1-bond fraction in the polyolefin chain are determined.

The 1,3-bond fraction and the 2,1-bond fraction of a propylene homopolymer can be calculated according to the following formulae based on the results of the above-mentioned measurement of the ¹³C-NMR spectrum.

1,3-bond fraction=(D/2)/(A+B+C+D)×100 (mol %)

2,1-bond fraction=RA+B)/21/(A+B+C+D)×100 (mol %)

A: value of integral at 15 to 15.5 ppm

B: value of integral at 17 to 18 ppm

C: value of integral at 19.5 to 22.5 ppm

D: value of integral at 27.6 to 27.8 ppm

### (a1) Meso Pentad Fraction [Mmmm]

In the case where the amorphous propylenic polymer is a propylene homopolymer, the meso pentad fraction [mmmm] thereof is, from the viewpoint that when used as a plasticizer, it can effectively soften the resin composition and the hot-melt adhesive, preferably less than 20 mol %, more preferably 15 mol % or less, even more preferably 10 mol % or less.

(a2) Racemic Pentad Fraction [rrrr]

In the case where the amorphous propylenic polymer is a propylene homopolymer, the racemic pentad fraction [rrrr] thereof is, from the viewpoint that when used as a plasticizer, it can effectively soften the resin composition and the hot-melt adhesive, preferably less than 25 mol %, more preferably 20 mol % or less, even more preferably 15 mol % or less.

### (b) 1,3-Bond Fraction and 2,1-Bond Fraction

The 1,3-bond fraction of the amorphous propylenic polymer is preferably less than 0.3 mol %, more preferably less than 0.1 mol %, even more preferably 0 mol %. Also preferably, the 2,1-bond fraction thereof is less than 0.3 mol %, more preferably less than 0.1 mol %, even more preferably 0 mol %. Falling within the range, the compatibility with a thermoplastic resin and a tackifier is bettered, and therefore the advantageous effects of the present invention can be more favorably exerted.

The 1,3-bond fraction and the 2,1-bond fraction can be controlled by the structure of the main catalyst and the polymerization condition. Specifically, the structure of the main catalyst has a great influence, and by narrowing the monomer insertion site around the central metal of the main catalyst, the 1,3-bond fraction and the 2,1-bond fraction can be controlled, but on the contrary, by broadening the insertion site, the 1,3-bond fraction and the 2,1-bond fraction can be increased. For example, a catalyst called a half-metallocene type catalyst has a broad insertion site around the central metal, and therefore readily forms the 1,3-bond fraction and the 2,1-bond fraction, and structures such as a long-chain branched structure. A racemic metallocene catalyst is expected to reduced the 1,3-bond fraction and the 2,1-bond fraction, but the racemic catalyst causes increased stereoregularity, and therefore can hardly produce amorphous polymers such as those shown in the present invention. For example, using a racemic double-crosslinked metallocene catalyst to be mentioned below, in which a substituent is introduced into the 3-position and the insertion site of the central metal is controlled, a polymer can be obtained in which the 1,3-bond fraction and the 2,1-bond fraction are reduced greatly.

Preferably, the amorphous propylenic polymer further satisfies the following (c) and (d):

(c) the glass transition temperature, measured with a differential scanning calorimeter (DSC), is −15° C. or higher,

(d) the melt viscosity at 190° C. is 1,000 mPa·s or less.

The glass transition temperature (Tg) of the amorphous propylenic polymer, measured with a differential scanning calorimeter (DSC), is preferably −15° C. or higher, more preferably −10° C. or higher. Though not limited, the upper limit is 15° C. or lower. When Tg is higher than −15° C., the compatibility with a thermoplastic resin and a tackifier is bettered, and therefore the advantageous effects of the present invention can be more favorably exerted. Further, in the case where the hot-melt adhesive contains the amorphous propylenic polymer according to the present invention, the adhesion strength at low temperatures can be sufficient, and the amount of the tackifier to be in the hot-melt adhesive is expected to be reduced.

The melt viscosity at 190° C. of the amorphous propylenic polymer is preferably 1,000 mPa·s or less, more preferably 750 mPa·s or less, even more preferably 500 mPa·s or less. Though not limited, the lower limit is preferably 50 mPa·s or more. When the melt viscosity is 1,000 mPa·s or less, the flowability in melt of the resin composition improves and the coatability in use as a hot-melt adhesive betters.

The melt viscosity can be measured using a TVB-15 series Brookfield model rotary viscometer (with M2 rotor) at 190° C. according to JIS K6862.

In the amorphous propylenic polymer, the number of terminal unsaturated groups per one molecule is, from the viewpoint of reactivity, preferably less than 0.5, more preferably less than 0.4, even more preferably less than 0.3. When the number of the terminal unsaturated groups per one molecule is less than 0.5, the polymer has no risk of reacting with any other component, and is therefore favorable as a plasticizer.

From the above, a preferred amorphous propylenic polymer for use in the plasticizer for resins of the present invention satisfies the following (1) to (9):

(1) the weight-average molecular weight (Mw) is 5,000 to 30,000,

(2) the molecular weight distribution (Mw/Mn) is 3.0 or less,

(3) the meso pentad fraction [mmmm] is less than 20 mol %,

(4) the racemic pentad fraction [rrrr] is less than 25 mol %,

(5) the 1,3-bond fraction is less than 0.3 mol %,

(6) the 2,1-bond fraction is less than 0.3 mol %,

(7) the glass transition temperature is −15° C. or higher,

(8) the melt viscosity at 190° C. is 1,000 mPa·s or less,

(9) the number of the terminal unsaturated groups per one molecule is less than 0.5.

### <Production Method for Amorphous Propylenic Polymer>

As the production method for the amorphous propylenic polymer for use in the plasticizer for resins of the present invention and the resin composition to be mentioned hereinunder, there is mentioned a method for producing a propylene homopolymer or a propylene copolymer by homopolymerizing or copolymerizing propylene or propylene and any other α-olefin, using a metallocene catalyst.

Examples of the metallocene-based catalyst include catalysts obtained by combining a transition metal compound containing one or two ligands selected from a cyclopentadienyl group, a substituted cyclopentadienyl group, an indenyl group, and a substituted indenyl group, and transition metal compound in which the above ligands are geometrically controlled, with a promoter, as described in JPS58-19309A, JPS61-130314A, JPH03-163088A, JPH04-300887A, JPH04-211694A, JPH01-502036A, and the like.

In the present invention, among the metallocene catalysts, a case where a catalyst is composed of a transition metal compound in which a ligand forms a crosslinked structure through a crosslinking group is preferred, and above all, a method using a metallocene catalyst obtained by combining a transition metal compound, in which a crosslinked structure is formed through two crosslinking groups, with a promoter is more preferred.

Specific examples of the method include a method of homopolymerizing propylene or 1-butene and a method of copolymerizing 1-butene and propylene (and further, an α-olefin having 5 to 20 carbon atoms to be used as needed), in which the homopolymerization or the copolymerization is carried out in the presence of a polymerization catalyst containing (A) a transition metal compound represented by the general formula (I), and (B) a component selected from (B-1) a compound capable of reacting with the transition metal compound as the component (A) or a derivative thereof to form an ionic complex and (B-2) an aluminoxane.

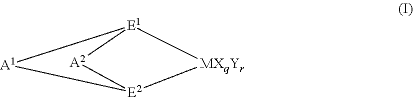

[In the formula, M represents a metal element of Groups 3 to 10 of the Periodic Table or a metal element of the lanthanoid series. E¹ and E² each represent a ligand selected from a substituted cyclopentadienyl group, an indenyl group, a substituted indenyl group, a heterocyclopentadienyl group, a substituted heterocyclopentadienyl group, an amide group, a phosphide group, a hydrocarbon group, and a silicon-containing group, and form a crosslinked structure through A¹ and A², and further, E¹ and E² may be the same as or different from each other. X represents a σ-bonding ligand, and when plural X's are present, plural X's may be the same as or different from each other and may be crosslinked with any other X, E¹, E², or Y. Y represents a Lewis base, and when plural Y's are present, plural Y's may be the same as or different from each other and may be crosslinked with any other Y, E¹, E², or X. A¹ and A² are each a divalent crosslinking group, which bonds two ligands, and each represent a hydrocarbon group having 1 to 20 carbon atoms, a halogen-containing hydrocarbon group having 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR′, or —AlR¹—, in which R¹ represents a hydrogen atom, a halogen atom, a hydrocarbon group having 1 to 20 carbon atoms, or a halogen-containing hydrocarbon group having 1 to 20 carbon atoms, and A¹ and A² may be the same as or different from each other. q is an integer of 1 to 5 and represents [(the valence of M)-2], and r represents an integer of 0 to 3.1

In the above general formula (I), M represents a metal element of Groups 3 to 10 of the Periodic Table or a metal element of the lanthanoid series, and specific examples thereof include titanium, zirconium, hafnium, yttrium, vanadium, chromium, manganese, nickel, cobalt, palladium, and lanthanoid series metals. Among these, from the viewpoint of the olefin polymerization activity and the like, metal elements of Group 4 of the Periodic Table are preferred, and particularly, titanium, zirconium, and hafnium are preferred.

E¹ and E² each represent a ligand selected from a substituted cyclopentadienyl group, an indenyl group, a substituted indenyl group, a heterocyclopentadienyl group, a substituted heterocyclopentadienyl group, an amide group (—N<), a phosphine group (—P<), a hydrocarbon group [>CR—, >C<], and a silicon-containing group [>SiR—, >Si<] (where R is hydrogen or a hydrocarbon group having 1 to 20 carbon atoms or a heteroatom-containing group), and form a crosslinked structure through A¹ and A². E¹ and E² may be the same as or different from each other. As E¹ and E², a substituted cyclopentadienyl group, an indenyl group, and a substituted indenyl group are preferred. Examples of the substituent include a hydrocarbon group having 1 to 20 carbon atoms and a silicon-containing group.

Further, X represents a σ-bonding ligand, and in the case where plural X's are present, plural X's may be the same as or different from each other and may be crosslinked with any other X, E¹, E², or Y. Specific examples of this X include a halogen atom, a hydrocarbon group having 1 to 20 carbon atoms, an alkoxy group having 1 to 20 carbon atoms, an aryloxy group having 6 to 20 carbon atoms, an amide group having 1 to 20 carbon atoms, a silicon-containing group having 1 to 20 carbon atoms, a phosphide group having 1 to 20 carbon atoms, a sulfide group having 1 to 20 carbon atoms, and an acyl group having 1 to 20 carbon atoms.

Examples of the halogen atom include a chlorine atom, a fluorine atom, a bromine atom, and an iodine atom. Specific examples of the hydrocarbon group having 1 to 20 carbon atoms include an alkyl group such as a methyl group, an ethyl group, a propyl group, a butyl group, a hexyl group, a cyclohexyl group, and an octyl group; an alkenyl group such as a vinyl group, a propenyl group, and a cyclohexenyl group; an arylalkyl group such as a benzyl group, a phenylethyl group, and a phenylpropyl group; and an aryl group such as a phenyl group, a tolyl group, a dimethylphenyl group, a trimethylphenyl group, an ethylphenyl group, a propylphenyl group, a biphenyl group, a naphthyl group, a methylnaphthyl group, an anthracenyl group, and a phenanthryl group. Above all, an alkyl group such as a methyl group, an ethyl group, and a propyl group; and an aryl group such as a phenyl group are preferred.

Examples of the alkoxy group having 1 to 20 carbon atoms include an alkoxy group such as a methoxy group, an ethoxy group, a propoxy group, and a butoxy group; a phenylmethoxy group, and a phenylethoxy group. Examples of the aryloxy group having 6 to 20 carbon atoms include a phenoxy group, a methylphenoxy group, and a dimethylphenoxy group. Examples of the amide group having 1 to 20 carbon atoms include an alkylamide group such as a dimethylamide group, a diethylamide group, a dipropylamide group, a dibutylamide group, a dicyclohexylamide group, and a methylethylamide group; an alkenylamide group such as a divinylamide group, a dipropenylamide group, and a dicyclohexenylamide group; an arylalkylamide group such as a dibenzylamide group, a phenylethylamide group, and a phenylpropylamide group; and an arylamide group such as a diphenylamide group and a dinaphthylamide group. Examples of the silicon-containing group having 1 to 20 carbon atoms include a mono-hydrocarbon-substituted silyl group such as a methylsilyl group and a phenylsilyl group; a dihydrocarbon-substituted silyl group such as a dimethylsilyl group and a diphenylsilyl group; a trihydrocarbon-substituted silyl group such as a trimethylsilyl group, a triethylsilyl group, a tripropylsilyl group, a tricyclohexylsilyl group, a triphenylsilyl group, a dimethylphenylsilyl group, a methyldiphenylsilyl group, a tritolylsilyl group, and a trinaphthylsilyl group; a hydrocarbon-substituted silyl ether group such as a trimethylsilyl ether group; a silicon-substituted alkyl group such as a trimethylsilylmethyl group; and a silicon-substituted aryl group such as a trimethylsilylphenyl group. Above all, a trimethylsilylmethyl group, a phenyldimethylsilylethyl group are preferred.

Examples of the phosphide group having 1 to 40 carbon atoms include a dialkyl phosphide group such as a dimethyl phosphide group, a diethyl phosphide group, a dipropyl phosphide group, a dibutyl phosphide group, a dihexyl phosphide group, a dicyclohexyl phosphide group, and a dioctyl phosphide group; a dialkenyl phosphide group such as a divinyl phosphide group, a dipropenyl phosphide group, and a dicyclohexenyl phosphide group; a bis(arylalkyl) phosphide group such as a dibenzyl phosphide group, a bis(phenylethyl) phosphide group, and a bis(phenylpropyl) phosphide group; and a diaryl phosphide group such as a diphenyl phosphide group, a ditolyl phosphide group, a bis(dimethylphenyl) phosphide group, a bis(trimethylphenyl) phosphide group, a bis(ethylphenyl) phosphide group, a bis(propylphenyl) phosphide group, a bis(biphenyl) phosphide group, a bis(naphthyl) phosphide group, a bis(methylnaphthyl) phosphide group, a bis(anthracenyl) phosphide group, and a bis(phenanthryl) phosphide group.

Examples of the sulfide group having 1 to 20 carbon atoms include an alkyl sulfide group such as a methyl sulfide group, an ethyl sulfide group, a propyl sulfide group, a butyl sulfide group, a hexyl sulfide group, a cyclohexyl sulfide group, and an octyl sulfide group; an alkenyl sulfide group such as a vinyl sulfide group, a propenyl sulfide group, and a cyclohexenyl sulfide group; an arylalkyl sulfide group such as a benzyl sulfide group, a phenylethyl sulfide group, and a phenylpropyl sulfide group; and an aryl sulfide group such as a phenyl sulfide group, a tolyl sulfide group, a dimethylphenyl sulfide group, a trimethylphenyl sulfide group, an ethylphenyl sulfide group, a propylphenyl sulfide group, a biphenyl sulfide group, a naphthyl sulfide group, a methylnaphthyl sulfide group, an anthracenyl sulfide group, and a phenanthryl sulfide group.

Examples of the acyl group having 1 to 20 carbon atoms include an alkylacyl group such as a formyl group, an acetyl group, a propionyl group, a butyryl group, a valeryl group, a palmitoyl group, a stearoyl group, and an oleoyl group; an arylacyl group such as a benzoyl group, a toluoyl group, a salicyloyl group, a cinnamoyl group, a naphthoyl group, and a phthaloyl group; and an oxalyl group, a malonyl group, and a succinyl group, which are derived from oxalic acid, malonic acid, succinic acid, and the like, each being a dicarboxylic acid, respectively.

On the other hand, Y represents a Lewis base, and in the case where plural Y's are present, plural Y's may be the same as or different from each other and may be crosslinked with any other Y, E¹, E², or X. Specific examples of the Lewis base represented by this Y include amines, ethers, phosphines, and thioethers. Examples of the amines include amines having 1 to 20 carbon atoms, and specific examples thereof include alkylamines such as methylamine, ethylamine, propylamine, butylamine, cyclohexylamine, methylethylamine, dimethylamine, diethylamine, dipropylamine, dibutylamine, and dicyclohexylamine; alkenylamines such as vinylamine, propenylamine, cyclohexenylamine, divinylamine, dipropenylamine, and dicyclohexenylamine; arylalkylamines such as phenylethylamine, and phenylpropylamine; and arylamines such as phenylamine, diphenylamine and dinaphthylamine.

Examples of the ethers include aliphatic monoether compounds such as methyl ether, ethyl ether, propyl ether, isopropyl ether, butyl ether, isobutyl ether, n-amyl ether, and isoamyl ether; aliphatic mixed ether compounds such as methylethyl ether, methylpropyl ether, methylisopropyl ether, methyl-n-amyl ether, methylisoamyl ether, ethylpropyl ether, ethylisopropyl ether, ethylbutyl ether, ethylisobutyl ether, ethyl-n-amyl ether, and ethylisoamyl ether; aliphatic unsaturated ether compounds such as vinyl ether, allyl ether, methylvinyl ether, methylallyl ether, ethylvinyl ether, and ethylallyl ether; aromatic ether compounds such as anisole, phenetole, phenyl ether, benzyl ether, phenylbenzyl ether, α-naphthyl ether, and β-naphthyl ether; and cyclic ether compounds such as ethylene oxide, propylene oxide, trimethylene oxide, tetrahydrofuran, tetrahydropyran, and dioxane.

Examples of the phosphines include phosphines having 1 to 30 carbon atoms. Specific examples thereof include alkyl phosphines including monohydrocarbon-substituted phosphines such as methyl phosphine, ethyl phosphine, propyl phosphine, butyl phosphine, hexyl phosphine, cyclohexyl phosphine, and octyl phosphine; dihydrocarbon-substituted phosphines such as dimethyl phosphine, diethyl phosphine, dipropyl phosphine, dibutyl phosphine, dihexyl phosphine, dicyclohexyl phosphine, and dioctyl phosphine; trihydrocarbon-substituted phosphines such as trimethyl phosphine, triethyl phosphine, tripropyl phosphine, tributyl phosphine, trihexyl phosphine, tricyclohexyl phosphine, and trioctyl phosphine; monoalkenyl phosphines such as vinyl phosphine, propenyl phosphine, and cyclohexenyl phosphine; dialkenyl phosphines in which two hydrogen atoms of phosphine are each substituted with alkenyl; trialkenyl phosphines in which three hydrogen atoms of phosphine are each substituted with alkenyl; and arylphosphines including arylalkyl phosphines such as benzyl phosphine, phenylethyl phosphine, and p henylpropyl phosphine; diarylalkyl phosphines or aryldialkyl phosphines in which three hydrogen atoms of phosphine are each substituted with aryl or alkenyl; phenyl phosphine, tolyl phosphine, dimethylphenyl phosphine, trimethylphenyl phosphine, ethylphenyl phosphine, propylphenyl phosphine, biphenyl phosphine, naphthyl phosphine, methylnaphthyl phosphine, anthracenyl phosphine, and phenanthryl phosphine; di(alkylaryl) phosphines in which two hydrogen atoms of phosphine are each substituted with alkylaryl; and tri(alkylaryl)phosphines in which three hydrogen atoms of phosphine are each substituted with alkylaryl. Examples of the thioethers include the above-mentioned sulfides.

Next, A¹ and A² are each a divalent crosslinking group, which bonds two ligands, and each represent a hydrocarbon group having 1 to 20 carbon atoms, a halogen-containing hydrocarbon group having 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹—, or —AlR¹—, in which R¹ represents a hydrogen atom, a halogen atom, a hydrocarbon group having 1 to 20 carbon atoms, or a halogen-containing hydrocarbon group having 1 to 20 carbon atoms, and A¹ and A² may be the same as or different from each other. Examples of such a crosslinking group include a group represented by the following general formula.

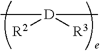

(D is carbon, silicon, or tin. R² and RP are each a hydrogen atom or a hydrocarbon group having 1 to 20 carbon atoms, and may be the same as or different from each other, or may be bonded to each other to form a ring structure. e represents an integer of 1 to 4.)

Specific examples thereof include a methylene group, an ethylene group, an ethylidene group, a propylidene group, an isopropylidene group, a cyclohexylidene group, a 1,2-cyclohexylene group, a vinylidene group (CH2═C<), a dimethylsilylene group, a diphenylsilylene group, a methylphenylsilylene group, a dimethylgermylene group, a dimethylstannylene group, a tetramethyldisilylene group, and a diphenyldisilylene group. Among these, an ethylene group, an isopropylidene group, and a dimethylsilylene group are preferred.

q is an integer of 1 to 5 and represents [(the valence of M)-2], and r represents an integer of 0 to 3.

Among such transition metal compounds represented by the general formula (I), a transition metal compound containing a double-crosslinked biscyclopentadienyl derivative as a ligand represented by the following general formula (II) is preferred.

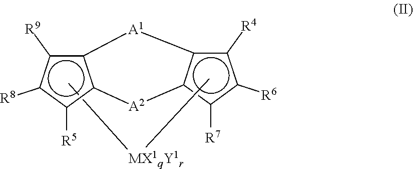

In the above general formula (II), M, A¹, A², q, and r are the same as described above.

X¹ represents a σ-bonding ligand, and when plural X's are present, plural X¹⁴s may be the same as or different from each other and may be crosslinked with any other X¹ or Y¹. Specific examples of this X¹ include the same ones as those given in the explanation of X in the general formula (I).

Y¹ represents a Lewis base, and when plural Y″s are present, plural Y″s may be the same as or different from each other and may be crosslinked with any other Y¹ or X¹. Specific examples of this Y¹ include the same ones as those given in the explanation of Y in the general formula (I). R⁴ to R⁹ each represent a hydrogen atom, a halogen atom, a hydrocarbon group having 1 to 20 carbon atoms, a halogen-containing hydrocarbon group having 1 to 20 carbon atoms, a silicon-containing group, or a heteroatom-containing group, and it is necessary that at least one of R⁴ to R⁹ should not be a hydrogen atom. Further, R⁴ to R⁹ may be the same as or different from each other, and the groups adjacent to each other may be bonded to each other to form a ring. Above all, it is preferred that R⁶ and R⁷ form a ring, and R⁸ and R⁹ form a ring. As R⁴ and R⁵, a group containing a heteroatom such as oxygen, halogen, or silicon is preferred because the polymerization activity is increased. As another preferred embodiment, it is preferred that R⁴ and R⁶ or R⁶ and R⁷ form a ring, and R⁵ and R⁸ or R⁸ and R⁹ form a ring. As the substituent in the case where R⁴ and R⁵, R⁷, or R⁹ do not form a ring, a group containing a heteroatom such as oxygen, halogen, or silicon is preferred because the polymerization activity is increased.

The transition metal compound containing this double-crosslinked biscyclopentadienyl derivative as a ligand preferably contains silicon in a crosslinking group between the ligands.

Specific examples of the transition metal compound represented by the general formula (I) include (1,1′-ethylene)(2,2′-tetramethyldisilylene)-bisindenylzirconium dichloride described in JP6263125B, (1,2′-diphenylsilylene) (2,1′-diphenylsilylene)bis(3-trimethylsilylmethylindenyl)zirconium dichloride described in WO2018/164161, and (1,1′-dimethylsilylene) (2,2′-tetramethyldisilyldene)bisindenylzirconium dichloride described in JP4902053B.

Next, any compound can be used as the component (B-1) in the components (B) as long as it is a compound which can be reacted with the transition metal compound as the component (A) described above to be able to form an ionic complex, however, a compound represented by the following general formula (III) or (IV) can be preferably used.

([L¹—R¹⁰]^{k+})ₐ([Z]⁻)_{b} (III)

([L²]^{k+})ₐ([Z]⁻)_{b} (IV)

(In the formulae, L2 is M¹, R11R12M2, R13C, or R¹⁴M³.)

In the above general formula (III), L¹ represents a Lewis base, R¹⁰ represents a hydrogen atom, an alkyl group having 1 to 20 carbon atoms, or a hydrocarbon group having 6 to 20 carbon atoms selected from an aryl group, an alkylaryl group and an arylalkyl group.

[Z]⁻ represents a non-coordinating anion [Z¹]⁻ or [Z²]⁻.

[Z¹]⁻ represents an anion in which plural groups are bonded to an element, that is, [M¹G¹G² . . . G^{f}]⁻. Here, M¹ represents an element of Groups 5 to 15 of the Periodic Table, preferably an element of Groups 13 to 15 of the Periodic Table. G¹ to G^{f} each represent a hydrogen atom, a halogen atom, an alkyl group having 1 to 20 carbon atoms, a dialkylamino group having 2 to 40 carbon atoms, an alkoxy group having 1 to 20 carbon atoms, an aryl group having 6 to 20 carbon atoms, an aryloxy group having 6 to 20 carbon atoms, an alkylaryl group having 7 to 40 carbon atoms, an arylalkyl group having 7 to 40 carbon atoms, a halogen-substituted hydrocarbon group having 1 to 20 carbon atoms, an acyloxy group having 1 to 20 carbon atoms, an organic metalloid group, or a heteroatom-containing hydrocarbon group having 2 to 20 carbon atoms. Two or more groups of G¹ to G^{f} may form a ring. f represents an integer of [(the valence of the central metal M³)±¹]).

[Z²]⁻ represents a conjugate base of a Bronsted acid, in which the logarithm of an inverse number of an acid dissociation constant (pKa) is −10 or less, alone or a combination of a Bronsted acid and a Lewis acid, or a conjugate base of an acid generally defined as an ultrastrong acid. Further, a Lewis base may be coordinated.

R¹⁰ represents a hydrogen atom, an alkyl group having 1 to 20 carbon atoms, or an aryl group, alkylaryl group or arylalkyl group having 6 to 20 carbon atoms.

R¹¹ and R¹² each independently represent a cyclopentadienyl group, a substituted cyclopentadienyl group, an indenyl group, or a fluorenyl group, and R¹³ represents an alkyl group having 1 to 20 carbon atoms, or a hydrocarbon group having 6 to 20 carbon atoms selected from an aryl group, an alkylaryl group, and an arylalkyl group. R¹⁴ represents a large cyclic ligand such as tetraphenylporphyrin or phthalocyanine. k is the ionic valence of each of [L¹—R¹⁰] and [L²], and represents an integer of 1 to 3, a represents an integer of 1 or more, and b is equivalent to (k×a). M² includes an element of Groups 1 to 3, 11 to 13, and 17 of the Periodic Table, and M³ represents an element of Groups 7 to 12 of the Periodic Table.

Here, specific examples of L¹ include ammonia, amines such as methylamine, aniline, dimethylamine, diethylamine, N-methylaniline, diphenylamine, N, N-dimethylaniline, trimethylamine, triethylamine, tri-n-butylamine, methyldiphenylamine, pyridine, p-bromo-N, N-dimethylaniline, and p-nitro-N,N-dimethylaniline, phosphines such as triethylphosphine, triphenylphosphine, and diphenylphosphine, thioethers such as tetrahydrothiophene, esters such as ethyl benzoate, and nitriles such as acetonitrile and benzonitrile.

Specific examples of R¹⁰ include a hydrogen atom, a methyl group, an ethyl group, a benzyl group, and a trityl group. Specific examples of R¹¹ and R¹² include a cyclopentadienyl group, a methylcyclopentadienyl group, an ethylcyclopentadienyl group, and a pentamethylcyclopentadienyl group. Specific examples of R¹³ include a phenyl group, a p-tolyl group, and a p-methoxyphenyl group. Specific examples of R¹⁴ include teteraphenylporphine, and phthalocyanine. Specific examples of M² include Li, Na, K, Ag, Cu, Br, I, and I₃. Specific examples of M³ include Mn, Fe, Co, Ni, and Zn.

Further, in [Z¹]⁻, that is, [M³G¹G² . . . G^{f}]⁻, specific examples of M¹ include B, Al, Si, P, As, and Sb, and preferred examples thereof include B and Al. Specific examples of G¹, G² to G^{f} include a dialkylamino group such as a dimethylamino group and a diethylamino group, an alkoxy group or an aryloxy group such as a methoxy group, an ethoxy group, an n-propoxy group, and a phenoxy group, a hydrocarbon group such as a methyl group, an ethyl group, an n-propyl group, an isopropyl group, an n-butyl group, an isobutyl group, an n-octyl group, an n-eicosyl group, a phenyl group, a p-tolyl group, a benzyl group, a 4-t-butylphenyl group, and a 3,5-dimethylphenyl group, a halogen atom such as fluorine, chlorine, bromine, and iodine, a heteroatom-containing hydrocarbon group such as a p-fluorophenyl group, a 3,5-difluorophenyl group, a pentachlorophenyl group, a 3,4,5-trifluorophenyl group, a pentafluorophenyl group, a 3,5-bis(trifluoromethyl)phenyl group, and a bis(trimethylsilyl)methyl group, and an organic metalloid group such as a pentamethylantimony group, a trimethylsilyl group, a trimethylgermyl group, a diphenylarsine group, a dicyclohexylantimony group, and diphenylboron group.

Also, specific examples of the non-coordinating anion, that is, the conjugate base [Z²]⁻ of a Bronsted acid having a pKa of −10 or less alone or a combination of a Bronsted acid with a Lewis acid include a trifluoromethanesulfonic acid anion (CF₃SO₃)⁻, a bis(trifluoromethanesulfonyl)methyl anion, a bis(trifluoromethanesulfonyl)benzyl anion, a bis(trifluoromethanesulfonyl)amide, a perchloric acid anion (C104)⁻, a trifluoroacetic acid anion (CF₃COO)⁻, a hexafluoroantimony anion (SbF₆)⁻, a fluorosulfonic acid anion (FSO₃)⁻, a chlorosulfonic acid anion (ClSO₃)⁻, a fluorosulfonic acid anion/an antimony pentafluoride (FSO₃/SbF₅)⁻, a fluorosulfonic acid anion/arsenic pentafluoride (FSO₃/AₛF₅)⁻, and trifluoromethanesulfonic acid/antimony pentafluoride (CF₃SO₃/SbF₅)⁻.

Specific examples of the ionic compound which is reacted with the transition metal compound as the component (A) described above to form an ionic complex, that is, the compound as the component (B-1) include triethylammonium tetraphenylborate, tri-n-butylammonium tetraphenylborate, trimethylammonium tetraphenylborate, tetraethylammonium tetraphenylborate, methyl(tri-n-butyl)ammonium tetraphenylborate, benzyl(tri-n-butyl)ammonium tetraphenylborate, dimethyldiphenylammonium tetraphenylborate, triphenyl(methyl)ammonium tetraphenylborate, trimethylanilinium tetraphenylborate, methylpyridinium tetraphenylborate, benzylpyridinium tetraphenylborate, methyl(2-cyanopyridinium) tetraphenylborate, triethylammonium tetrakis(pentafluorophenyl)borate, tri-n-butylammonium tetrakis(pentafluorophenyl)borate, triphenylammonium tetrakis(pentafluorophenyl)borate, tetra-n-butylammonium tetrakis(pentafluorophenyl)borate, tetraethylammonium tetrakis(pentafluorophenyl)borate, benzyl(tri-n-butyl) ammonium tetrakis(pentafluorophenyl)borate, methyldiphenylammonium tetrakis(pentafluorophenyl)borate, triphenyl(methyl) ammonium tetrakis(pentafluorophenyl)borate, methylanilinium tetrakis(pentafluorophenyl)borate, dimethylanilinium tetrakis(pentafluorophenyl)borate, trimethylanilinium tetrakis(pentafluorophenyl)borate, methylpyridinium tetrakis(pentafluorophenyl)borate, benzylpyridinium tetrakis(pentafluorophenyl)borate, methyl(2-cyanopyridinium) tetrakis(pentafluorophenyl)borate, benzyl(2-cyanopyridinium) tetrakis(pentafluorophenyl)borate, methyl(4-cyanopyridinium) tetrakis(pentafluorophenyl)borate, triphenylphosphonium tetrakis(pentafluorophenyl)borate, dimethylanilinium tetrakis [bis(3,5-ditrifluoromethyl)phenyl]borate, ferrocenium tetraphenylborate, silver tetraphenylborate, triethyl tetraphenylborate, tetraphenylporphyrinmanganese tetraphenylborate, ferrocenium tetrakis(pentafluorophenyl)borate, (1,1′-dimethylferrocenium) tetrakis(pentafluorophenyl)borate, decamethylferrocenium tetrakis(pentafluorophenyl)borate, silver tetrakis(pentafluorophenyl)borate, trityl tetrakis(pentafluorophenyl)borate, lithium tetrakis(pentafluorophenyl)borate, sodium tetrakis(pentafluorophenyl)borate, tetraphenylporphyrinmanganese tetrakis(pentafluorophenyl)borate, silver tetrafluoroborate, silver hexafluorophosphate, silver hexafluoroarsenate, silver perchlorate, silver trifluoroacetate, and silver trifluoromethanesulfonate.

As the component (B-1), one type may be used or two or more types may be used in combination.

On the other hand, examples of the organic aluminumoxy compound (B-2) include a chain aluminoxane represented by the following general formula (V), and a cyclic aluminoxane represented by the following general formula (VI).

A chain aluminoxane represented by the general formula (V):

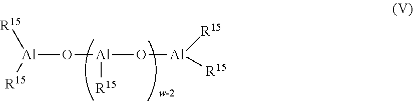

wherein R¹⁵ represents a hydrocarbon group having 1 to 20 carbon atoms, preferably 1 to 12 carbon atoms, or a halogen atom. The hydrocarbon group includes an alkyl group, an alkenyl group, an aryl group, and an arylalkyl group. w represents a polymerization degree and is an integer of usually 2 to 50, preferably 2 to 40. R¹⁵'s may be the same as or different from each other.

A cyclic aluminoxane represented by the general formula (VI):

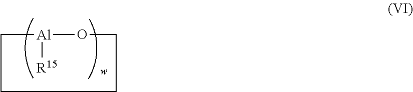

wherein R¹⁵ and w are the same as those in the above general formula (V).

Examples of the production method for the aluminoxane described above include a method in which alkylaluminum is brought into contact with a condensing agent such as water, but a means thereof is not particularly limited, and they may be reacted according to a known method. Examples of the method include a method in which an organic aluminum compound is dissolved in an organic solvent, and then the resulting solution is brought into contact with water, a method in which an organic aluminum compound is first added when carrying out polymerization, and then water is added thereto, a method in which an organic aluminum compound is reacted with crystal water contained in a metal salt, or water adsorbed on an inorganic substance or an organic substance, and a method in which trialkylaluminum is reacted with tetraalkyldialuminoxane and the reaction product is further reacted with water. The aluminoxane may be an aluminoxane which is insoluble in toluene.

Among these aluminoxanes, one type may be used or two or more types may be used in combination.

The use proportion of the component (A) to the component (B) in the present invention is, when the component (B-1) is used as the component (B), preferably 1/1 to 1/1,000,000, more preferably 1/10 to 1/10,000 in terms of molar ratio, while when the component (B-2) is used, the use proportion is preferably 10/1 to 1/100, more preferably 2/1 to 1/10 in terms of molar ratio. As the component (B), one of (B-1) and (B-2) can be used singly or two or more kinds thereof can be used as combined.

The polymerization catalyst in the present invention may contain the above component (A) and component (B) as main components, or may contain the component (A), the component (B) and an organic aluminum compound (C) as main components. Here, as the organic aluminum compound of the component (C), a compound represented by the following general formula (VII) can be used:

(R¹⁶)ᵥAlQ₃₋ᵥ (VII)

wherein R¹⁶ represents an alkyl group having 1 to 10 carbon atoms, Q represents a hydrogen atom, an alkoxy group having 1 to 20 carbon atoms, an aryl group having 6 to 20 carbon atoms, or a halogen atom, and v is an integer of 1 to 3.

Specific examples of the compound represented by the above general formula (VII) include trimethylaluminum, triethylaluminum, triisopropylaluminum, triisobutylaluminum, dimethylaluminum chloride, diethylaluminum chloride, methylaluminum dichloride, ethylaluminum dichloride, dimethylaluminum fluoride, diisobutylaluminum hydride, diethylaluminum hydride, and ethylaluminum sesquichloride.

Among these organic aluminum compounds, one type may be used or two or more types may be used in combination.

In the production method, preliminary contact can also be carried out using the component (A), the component (B), and the component (C) described above. The preliminary contact can be carried out by, for example, bringing the component (B) into contact with the component (A), but the method is not particularly limited, and a known method can be used. This preliminary contact is effective in the reduction in the catalyst cost due to the improvement of the catalyst activity, or the reduction in the use proportion of the component (B) which is a promoter. Further, by bringing the component (A) into contact with the component (B-2), an effect of improving the molecular weight can be seen in addition to the effect described above. The preliminary contact temperature is usually −20° C. to 200° C., preferably −10° C. to 150° C., more preferably 0° C. to 80° C. In the preliminary contact, an aliphatic hydrocarbon, or an aromatic hydrocarbon can be used as an inert hydrocarbon serving as a solvent. Among these, an aliphatic hydrocarbon is particularly preferred.

The use proportion of the component (A) to the component (C) is preferably 1/1 to 1/10,000, more preferably 1/5 to 1/2,000, further more preferably 1/10 to 1/1,000 in terms of molar ratio. By using the component (C), the activity per transition metal can be improved, however, in the case where the amount thereof is too much, the organic aluminum compound is not only wasted, but also remains in a large amount in the propylenic polymer, which is not preferred.

In the present invention, at least one of the catalyst components can be carried on a suitable carrier and used. The type of the carrier is not particularly limited, and any of an inorganic oxide carrier, an inorganic carrier other than the inorganic oxide carrier, and an organic carrier can be used. However, in particular, an inorganic oxide carrier or an inorganic carrier other than the inorganic oxide carrier is preferred.

Specific examples of the inorganic oxide carrier include SiO₂, Al₂O₃, MgO, ZrO₂, TiO₂, Fe₂O₃, B₂O₃, CaO, ZnO, BaO, ThO₂, and mixtures thereof such as silica alumina, zeolite, ferrite, and glass fiber. Among these, SiO₂ and Al₂O₃ are particularly preferred. The inorganic oxide carrier described above may contain a small amount of a carbonate, a nitrate, or a sulfate. On the other hand, examples of the carrier other than the inorganic oxide carrier described above include magnesium compounds represented by the general formula: Mg(R¹⁷)ₓX_{y} typified by MgCl₂, Mg(0C2H5)₂, and complex salts thereof. Here, R′⁷ represents an alkyl group having 1 to 20 carbon atoms, an alkoxy group having 1 to 20 carbon atoms, or an aryl group having 6 to 20 carbon atoms, x represents a halogen atom or an alkyl group having 1 to 20 carbon atoms, y is 0 to 2, b is 0 to 2, and x+y=2. R¹⁷'s or X's each may be the same as or different from each other.

Further, examples of the organic carrier include polymers such as polystyrene, styrene-divinylbenzene copolymers, polyethylene, polypropylene, substituted polystyrene, and polyallylate, as well as starch and carbon. As the carrier to be used in the present invention, MgCl₂, MgCl(0C2H5), Mg(0C2H5)₂, SiO₂, Al₂O₃ are preferred. The properties of the carrier vary depending on the type thereof and the production method, however, the average particle diameter is usually 1 to 300 μm, preferably 10 to 200 μm, more preferably 20 to 100 μm. When the particle diameter is small, a fine powder in the 1-octene/1-decene/1-dodecene tercopolymer increases, and when the particle diameter is large, a coarse particle in the 1-octene/1-decene/1-dodecene tercopolymer polymer increases to cause a reduction in the bulk density or the clogging of a hopper. The carrier has a specific surface area of usually 1 to 1,000 m²/g, preferably 50 to 500 m²/g, and a pore volume of usually 0.1 to 5 cm³/g, preferably 0.3 to 3 cm³/g. When either of the specific surface area and the pore volume deviates from the above range, the catalyst activity decreases in some cases. The specific surface area and the pore volume can be determined from the volume of adsorbed nitrogen gas according to, for example, a BET method. (See J. Am. Chem. Soc., 60, 309 (1983).) Further, the carrier is preferably used after it is fired at usually 150 to 1,000° C., preferably 200 to 800° C.

In the case where at least one of the catalyst components is carried on the carrier described above, it is desired to carry at least one of the component (A) and the component (B), preferably both of the component (A) and the component (B) on the carrier. The method for carrying at least one of the component (A) and the component (B) on the carrier is not particularly limited, however, for example, a method in which at least one of the component (A) and the component (B) is mixed with the carrier, a method in which the carrier is treated with an organic aluminum compound or a halogen-containing silicon compound, and then at least one of the component (A) and the component (B) is mixed therewith in an inert solvent, a method in which the carrier, the component (A) and/or the component (B), and an organic aluminum compound or a halogen-containing silicon compound are reacted with one another, a method in which the component (A) or the component (B) is carried on the carrier, and then the component (B) or the component (A) is mixed therewith, a method in which a contact reaction product of the component (A) and the component (B) is mixed with the carrier, and a method in which the carrier is allowed to coexist in the contact reaction of the component (A) and the component (B) can be used. In the above reactions, it is also possible to add the organic aluminum compound as the component (C).

In the present invention, the catalyst may be prepared by irradiating an elastic wave when the components (A), (B), and (C) described above are brought into contact. As the elastic wave, generally a sonic wave, particularly preferably an ultrasonic wave can be exemplified. To be specific, an ultrasonic wave with a frequency of 1 to 1,000 kHz, preferably an ultrasonic wave with a frequency of 10 to 500 kHz can be given as examples.

The catalyst thus obtained may be used for polymerization after the solvent is evaporated off and the catalyst in the form of a solid is taken out or may be used for polymerization as it is.

Further, in the present invention, the catalyst can be produced by performing an operation of carrying at least one of the component (A) and the component (B) on the carrier in the polymerization system. For example, a method in which at least one of the component (A) and the component (B) and the carrier and, if necessary, the organic aluminum compound as the component (C) are added, and an olefin such as ethylene is added at an atmospheric pressure to 2 MPa (gauge) to carry out preliminary polymerization at −20 to 200° C. for about one minute to two hours, thereby forming catalyst particles can be used.

In the present invention, it is desired that the use proportion of the component (B-1) to the carrier is preferably 1/0.5 to 1/1,000, more preferably 1/1 to 1/50 in terms of mass ratio, and the use proportion of the component (B-2) to the carrier is preferably 1/5 to 1/10,000, more preferably 1/10 to 1/500 in terms of mass ratio. In the case where two or more components as the components (B) are mixed and used, the use proportion of each of the catalyst components (B) to the carrier is desirably in the above range in terms of mass ratio. Further, it is desired that the use proportion of the component (A) to the carrier is preferably 1/5 to 1/10,000, more preferably 1/10 to 1/500 in terms of mass ratio. The catalyst in the present invention may contain the component (A), the component (B) and the component (C) as main components. The use proportion of the component (B) to the carrier and the use proportion of the component (A) to the carrier each preferably fall within the above-mentioned range in terms of mass ratio. The amount of the component (C) in that case is, as described above, in terms of molar ratio to the component (A), preferably 1/1 to 1/10,000, more preferably 1/5 to 1/2,000, even more preferably 1/10 to 1/1,000. In the case where the use proportion of the component (B) (the component (B-1) or the component (B-2)) to the carrier, the use proportion of the component (A) to the carrier, or the use proportion of the component (C) to the component (A) deviates from the above range, the activity decreases in some cases. The thus prepared catalyst has an average particle diameter of usually 2 to 200 μm, preferably 10 to 150 μm, particularly preferably 20 to 100 μm, and has a specific surface area of usually 20 to 1000 m²/g, preferably 50 to 500 m²/g. When the average particle diameter is less than 2 μm, a fine powder in the polymer increases in some cases, and when the average particle diameter exceeds 200 μm, a coarse particle in the polymer increases in some cases. When the specific surface area is less than 20 m²/g, the activity decreases in some cases, and when the specific surface area exceeds 1,000 m²/g, the bulk density of the polymer decreases in some cases. Further, in the catalyst, the amount of the transition metal in 100 g of the carrier is usually 0.05 to 10 g, particularly preferably 0.1 to 2 g. When the amount of the transition metal is outside of the above range, the activity decreases in some cases. An industrially advantageous polymer having a high bulk density and an excellent particle size distribution can be obtained by carrying the catalyst on the carrier in the manner described above.

For the amorphous propylenic polymer for use in the plasticizer for resins of the present invention and the resin composition described below, propylene may be homopolymerized to give a propylene homopolymer, or propylene and ethylene or any other α-olefin may be copolymerized to give a propylene copolymer, using the above-mentioned polymerization catalyst.

In that case, the polymerization method is not specifically limited, and any method such as a slurry polymerization method, a gas-phase polymerization method, a bulk polymerization method, a solution polymerization method, or a suspension polymerization method may be used, however, a slurry polymerization method and a gas-phase polymerization method are particularly preferred.

With respect to the polymerization conditions, the polymerization temperature is usually −100 to 250° C., preferably −50 to 200° C., more preferably 0 to 130° C. With respect to the use proportion of the catalyst to the reaction starting material, the starting material monomer/the component (A) described above (molar ratio) is preferably 10⁵ to 10⁸, particularly preferably 10⁶ to 10⁷. The polymerization time is usually 5 minutes to 10 hours, and the reaction pressure is preferably an atmospheric pressure to 3 MPa (gauge), more preferably an atmospheric pressure to 2 MPa (gauge).

Examples of the method for controlling the molecular weight of the polymer include selection of the type of the respective catalyst components, the use amount, or the polymerization temperature, and polymerization in the presence of hydrogen.

In the case of using a polymerization solvent, for example, an aromatic hydrocarbon such as benzene, toluene, xylene, or ethylbenzene, an alicyclic hydrocarbon such as cyclopentane, cyclohexane, or methylcyclohexane, an aliphatic hydrocarbon such as pentane, hexane, heptane, or octane, a halogenated hydrocarbon such as chloroform or dichloromethane can be used. Among these solvents, one type may be used alone or two or more types may be used in combination. Further, a monomer such as an α-olefin may be used as the solvent. The polymerization can be carried out without using a solvent depending on the polymerization method.

In the polymerization, preliminary polymerization can be carried out using the polymerization catalyst described above. The preliminary polymerization can be carried out by bringing, for example, a small amount of a monomer into contact with the catalyst component. However, the method is not particularly limited, and a known method can be used. The monomer to be used for the preliminary polymerization is not particularly limited, and for example, propylene, ethylene, an α-olefin having 4 to 20 carbon atoms, or a mixture thereof can be given. However, it is advantageous to use the same monomer as used in the polymerization. The preliminary polymerization temperature is usually −20 to 200° C., preferably −10 to 130° C., more preferably 0 to 80° C. In the preliminary polymerization, an inert hydrocarbon, an aliphatic hydrocarbon, an aromatic hydrocarbon, or a monomer can be used as a solvent. Among these, an aliphatic hydrocarbon and an aromatic hydrocarbon are particularly preferred. The preliminary polymerization may be carried out without using a solvent.

In the preliminary polymerization, it is desired to control the conditions so that the limiting viscosity [₁] (measured in decalin at 135° C.) of the preliminary polymerization product is 0.2 dL/g or more, particularly 0.5 dL/g or more, and the amount of the preliminary polymerization product per millimole of the transition metal component in the catalyst is 1 to 10,000 g, particularly 10 to 1,000 g.

### [Method for Reducing Viscosity in Melt of Resin Composition and Imparting Elongation Characteristics Thereto]

The resin composition of the present invention can be used in various applications. Examples of the target in the case where the amorphous propylenic polymer in the present invention is used as a plasticizer for resins include a resin composition, a molded article and a hot-melt adhesive.

In the case where the plasticizer for resins of the present invention is, for example, targeted to a resin composition containing a thermoplastic resin to be mentioned below, the plasticizer for resins of the present invention, preferably the amorphous propylenic polymer can be used for reducing the viscosity in melt of the resin composition and for imparting elongation characteristics to the resin composition.

Accordingly the embodiment of the present invention includes a method of reducing the viscosity in melt of a resin composition containing a thermoplastic resin and imparting elongation characteristics to the resin composition, using the plasticizer for resins.

Further, when the amorphous propylenic polymer is mixed with a thermoplastic resin to give a resin composition, the thermoplastic resin can be given high adhesivity and transparency. Consequently, a resin composition containing the amorphous propylenic polymer and a thermoplastic resin has high adhesivity and transparency.

### <Resin Composition>

The resin composition for use in the above-mentioned method of the present invention contains the above-mentioned plasticizer for resins and a thermoplastic resin.

In addition, the resin composition containing the amorphous propylenic polymer (AA) having a weight-average molecular weight (Mw), measured according to a GPC method, of 5,000 to 30,000 and having a molecular weight distribution (Mw/Mn) of 3.0 or less, and the polyolefinic polymer (BB) having a melting point of 20° C. or higher and 160° C. or lower and ΔH of 5 J/g or more and 100 J/g or less is also described in this section.

The content of the plasticizer for resins in the resin composition is, from the viewpoint of the balance of pressure-sensitive adhesivity, tackiness and retentivity, preferably 5% by mass or more and 95% by mass or less, more preferably 10% by mass or more and 90% by mass or less, even more preferably 15% by mass or more and 85% by mass or less, further more preferably 20% by mass or more and 80% by mass or less.

The content of the amorphous propylenic polymer in the resin composition is, from the viewpoint of the balance of pressure-sensitive adhesivity, tackiness and retentivity, preferably 5% by mass or more and 95% by mass or less, more preferably 10% by mass or more and 90% by mass or less, even more preferably 15% by mass or more and 85% by mass or less, further more preferably 20% by mass or more and 80% by mass or less.

Especially in the case where the above-mentioned amorphous propylenic polymer (AA) is used in the resin composition, preferably the resin composition contains the amorphous propylenic polymer (AA) having a weight-average molecular weight (Mw), measured according to a GPC method, of 5,000 to 30,000 and having a molecular weight distribution (Mw/Mn) of 3.0 or less, and the polyolefinic polymer (BB) having a melting point of 20° C. or higher and 160° C. or lower and ΔH of 5 J/g or more and 100 J/g or less.

As amorphous, the propylenic polymer (AA) can efficiently soften the resin composition. The resin composition is by itself excellent in elongation and is therefore characterized in that a large amount of an oil or a liquid polyisobutylene need not to be added thereto, and that it has a low VOC and is poorly odoriferous. Further, the hot-melt adhesive using the resin composition also is characterized in that it has a low VOC and is poorly odoriferous. Specifically, the resin composition is excellent in elongation though having a low viscosity in melt.

The content of the amorphous propylenic polymer (AA) in the resin composition is, from the viewpoint of the balance of pressure-sensitive adhesivity, tackiness and retentivity, preferably 5% by mass or more and 95% by mass or less, more preferably 10% by mass or more and 90% by mass or less, even more preferably 15% by mass or more and 85% by mass or less, further more preferably 20% by mass or more and 80% by mass or less.

### <Thermoplastic Resin>

The thermoplastic resin contained in the resin composition is, though not specifically limited but from the viewpoint of the compatibility with the plasticizer for resins, preferably a polyolefinic resin. Also though not specifically limited, the polyolefinic resin is preferably a (co)polymer of an olefin having 2 to 20 carbon atoms, more preferably a (co)polymer of an olefin having 2 to 12 carbon atoms, even more preferably at least one selected from a propylenic polymer and a copolymer of ethylene and an α-olefin, even more preferably at least one selected from a propylene homopolymer, a copolymer of ethylene and propylene, a copolymer of ethylene, propylene and 1-butene, and a copolymer of ethylene and an α-olefin having 6 or more carbon atoms.

Also from the viewpoint of imparting elongation characteristics, preferred is a polyolefinic resin, more preferred is a propylenic polymer, and even more preferred is a propylene homopolymer.

The content of the thermoplastic resin in the resin composition is, from the viewpoint of expressing pressure-sensitive adhesivity and tackiness, preferably 5% by mass or more and 95% by mass or less, more preferably 10% by mass or more and 90% by mass or less, even more preferably 15% by mass or more and 85% by mass or less, further more preferably 20% by mass or more and 80% by mass or less.

### <Polyolefinic Polymer (BB)>

The polyolefinic polymer (BB) is also a thermoplastic resin, and is more preferably used as a component of the resin composition.

The polyolefinic polymer (BB) contained in the resin composition has a melting point (Tm) of 20° C. or higher and 160° C. or lower and has a melting endothermic amount (ΔH) of 5 Jig or more and 100 Jig or less. The melting point Tm and the melting endothermic amount ΔH are measured according to the methods described in Examples.

When a high-melting-point polyolefin is contained in coating by thermal melting, such as hot melt coating or calender coating, high temperatures may be needed in coating, and if so, coating could not be attained on some type of substrates. In addition, such a high-melting-point polyolefin hardly dissolves in a solvent such as toluene, and therefore there may occur some other trouble that high concentration could not be attained in solvent casting. In addition, when the melting point and the melting endothermic amount ΔH are low, retentivity may be insufficient. Consequently, the melting point of the polyolefinic polymer (BB) is, from the viewpoint of coatability and from the viewpoint of the balance with retentivity, 20° C. or higher and 160° C. or lower, preferably 20° C. or higher and 140° C. or lower, more preferably 20° C. or higher and 120° C. or lower. Also from the viewpoint of coatability and from the viewpoint of the balance with retentivity, the melting endothermic amount ΔH of the polyolefinic polymer (BB) is 5 J/g or more and 100 J/g or less, preferably 5 J/g or more and 90 J/g or less, more preferably 5 J/g or more and 80 J/g or less.

In the case of using as a raw material for the resin composition or the hot-melt adhesive, from the viewpoint of coatability, the viscosity in melt of the polyolefinic polymer (BB) is preferably within a specific range. Specifically, the melt viscosity of the polyolefinic polymer (BB) at 190° C. is preferably 1,000 mPa·s or more and 50,000 mPa·s or less, more preferably 1,500 mPa·s or more and 40,000 mPa·s or less, even more preferably 2,000 mPa·s or more and 30,000 mPa·s or less.

The melt viscosity can be measured using a TVB-15 series Brookfield model rotary viscometer (with M2 rotor) at 190° C. according to JIS K6862.

The content of the polyolefinic polymer (BB) in the resin composition is, from the viewpoint of expressing pressure-sensitive adhesivity and tackiness, preferably 5% by mass or more and 95% by mass or less, more preferably 10% by mass or more and 90% by mass or less, even more preferably 15% by mass or more and 85% by mass or less, further more preferably 20% by mass or more and 80% by mass or less.

Though not specifically limited, the polyolefinic polymer (BB) is preferably a (co)polymer of an olefin having 2 to 20 carbon atoms, more preferably a (co)polymer of an olefin having 2 to 12 carbon atoms, even more preferably at least one selected from a propylenic polymer and a copolymer of ethylene and an α-olefin, even more preferably at least one selected from a propylene homopolymer, a copolymer of ethylene and propylene, a copolymer of ethylene, propylene and 1-butene, and a copolymer of ethylene and an α-olefin having 6 or more carbon atoms.

Also from the viewpoint of imparting elongation characteristics, preferred is a polyolefinic resin, more preferred is a propylenic polymer, and even more preferred is a propylene homopolymer.

A propylenic polymer is preferably used as more readily exerting the advantageous effects of the present invention.

### (Production Method for Polyolefinic Polymer (BB))

A production method for a polyolefinic polymer includes a method of homopolymerizing propylene or 1-butene to give a propylene homopolymer or a 1-butene homopolymer, using a metallocene catalyst or a Ziegler-Natta catalyst, a method of copolymerizing ethylene, 1-butene and propylene (and further optionally an α-olefin having 5 to 20 carbon atoms) to give a 1-butene-propylene copolymer or an ethylene-1-butene-propylene copolymer, and a method of copolymerizing ethylene and an α-olefin having 6 to 20 carbon atoms to give a copolymer. By appropriately selecting the catalyst and by controlling the monomer concentration, the degree of crystallinity of the polyolefin to be obtained can be controlled. Regarding the method for controlling the molecular weight of polymer, the kind of the components of the catalyst, the amount to be used thereof and the polymerization temperature are selected, and the polymerization is carried out in the presence of hydrogen.

Commercial products of the polyolefinic polymer (BB) favorably usable in the resin composition include “L-MODU” series (by Idemitsu Kosan Co., Ltd.), “Exact” series and “VISTAMAXX” series (both by Exxon Mobil Chemical Corporation), “Affinity Polymer” series (by Dow Chemical Corporation), “VESTOPLAST” series (by Evonik Industries AG), “LICOCENE” series (by Clariant AG) (all are registered trademarks).

### <Tackifier>

The Resin Composition can Further Contain a Tackifier.

Examples of the tackifier include materials which are composed of a rosin derivative resin, a polyterpene resin, a petroleum resin, or an oil-soluble phenolic resin and are in the form of a solid, a semi-solid, or a liquid at normal temperature. Among these materials, one type may be used alone or two or more types may be used in combination. In the present invention, it is preferred to use a hydrogenated material. In particular, a hydrogenated petroleum resin material having excellent heat stability is more preferred. Examples of commercially available products of the tackifier include I-MARV P-125, I-MARV P-100, and I-MARV P-90 (all by Idemitsu Kosan Co., Ltd.), Yumex 1001 (by Sanyo Chemical Industries, Ltd.), Hi-Rez T 1115 (by Mitsui Chemicals, Inc.), Clearon K 100 (by Yasuhara Chemical Co., Ltd.), ECR 227 and Escorez 5300 (both by both by Exxon Mobil Chemical Corporation), Arkon P-100 (by Arakawa Chemical Industries, Ltd.), and Regalrez 1078 (by Hercules, Inc.) (all are trade names).

The content of the tackifier in the resin composition is preferably 50% by mass or less, more preferably 5% by mass or more and 40% by mass or less, even more preferably 10% by mass or more and 30% by mass or less.

### [Other Components]

### (Solvent)

The resin composition may contain a solvent. Specific examples of the solvent include organic solvents such as ethyl acetate, acetone, tert-butyl alcohol, glycerin, ethylene glycol, triethylene glycol, ethylene glycol monomethyl ether, ethylene glycol monomethyl ether acetate, diethylene glycol dimethyl ether, ethylene glycol dimethyl ether acetate, ethyl cellosolve, ethyl cellosolve acetate, butyl cellosolve, butyl cellosolve acetate, etc., and aromatic hydrocarbons such as benzene, toluene, xylene, ethylbenzene, methoxybenzene, 1,2-dimethoxybenzene, hexane, cyclohexane, heptane, and pentane.

### (Additives)

The resin composition can contain, in addition to the above-mentioned components, various additives within a range not interfering with the advantageous effects of the present invention. Examples of the additives include an oil, a wax, other plasticizer, a filler, an antioxidant, a foaming agent, a weather stabilizer, a UV absorbent, a light stabilizer, a heat-resistant stabilizer, an antistatic agent, a flame retardant, a synthetic oil, a wax, an electrical property improver, a viscosity regulator, a coloration inhibitor, an anti-fogging agent, a pigment, a dye, a softener, an antiaging agent, a hydrochloric acid absorbent, and a chlorine scavenger.

Examples of the oil include a paraffinic process oil, a naphthenic process oil and an isoparaffinic oil.

Commercial products of the paraffinic process oil include “Diana Process Oil PW-32”, “Diana Process Oil PW-90”, “Diana Process Oil PW-150”, “Diana Process Oil PS-32”, “Diana Process Oil PS-90”, “Diana Process Oil PS-430” (all by Idemitsu Kosan Co., Ltd.), “Kaydol Oil”, “ParaLux Oil” (trade name by Chevron USA Corporation), and “Ragalrez 101” (trade name by Eastman Chemical Company).

Commercial products of the isoparaffinic oil include “IP Solvent 2028”, “IP Solvent 2835” (both trade names by Idemitsu Kosan Co., Ltd.), and “NA Solvent series” (trade name by NOF Corporation).

Examples of the wax include animal wax, vegetable wax, carnauba wax, candelilla wax, Japan tallow, beeswax, mineral wax, petroleum wax, paraffin wax, microcrystalline wax, petrolatum, higher fatty acid wax, higher fatty acid ester wax, and Fischer-Tropsch wax.

Examples of the other plasticizer include phthalates, adipates, fatty acid esters, glycols, and epoxy-type polymer plasticizer.

Examples of the filler include talc, calcium carbonate, barium carbonate, wollastonite, silica, clay, mica, kaolin, titanium oxide, diatomaceous earth, urea resin, styrene bead, starch, barium sulfate, calcium sulfate. magnesium silicate, magnesium carbonate, alumina and quartz powder.

Examples of the antioxidant include phosphorus-based antioxidants such as trisnonylphenyl phosphite, distearylpentaerythritol diphosphate, “ADEKASTAB 1178” (by ADEKA Corporation), “Sumilizer TNP” (by Sumitomo Chemical Co., Ltd.), “Irgafos 168” (by BASF Corporation), and “Sandstab P-EPQ” by Sandoz Corporation”, phenol-based antioxidants such as 2,6-di-t-butyl-4-methylphenol, n-octadecyl-3-(3′,5′-di-t-butyl-4′-hydroxyphenyl propionate, “Sumilizer BHT” (by Sumitomo Chemical Co., Ltd.), and “Irganox 1010” (by BASF Corporation), and sulfur-based antioxidants such as dilauryl-3,3′-thiodipropionate, pentaerythritol tetrakis(3-laurylthiopropionate), “Sumilizer TPL” (by Sumitomo Chemical Co., Ltd.), “DLTP Yoshitomi” (by Mitsubishi Chemical Corporation.), and “Antiox L” (by NOF Corporation).

### <Production Method for Resin Composition>

The above-mentioned resin composition and the resin composition for use in the method of the present invention can be produced by dry-blending a mixture of the above-mentioned plasticizer for resins (preferably the amorphous propylenic polymer) and the above-mentioned thermoplastic resin (preferably the polyolefinic polymer (BB)) preferably along with a tackifier resin and optionally various other additives, in a Henschel mixer, and melt-kneading the resultant mixture with a single-screw or twin-screw extruder, or a Plastomill or a Banbury mixer, or the like.

### <Properties of Resin Composition>

Preferably, the resin composition has the following properties.

From the viewpoint of coatability in the case of using as a hot-melt adhesive, the melt viscosity of the resin composition at 190° C. is preferably 7,000 mPa·s or less, more preferably 6,000 mPa·s or less, even more preferably 5,000 mPa·s or less, further more preferably 4,000 mPa·s, further more preferably 3,000 mPa·s or less. The lower limit is not limited but is preferably 300 mPa·s or more, and from the viewpoint of adhesivity as a hot-melt adhesive, the lower limit can be, for example, 1,000 mPa·s. When the melt viscosity falls within the above range, the resin composition is excellent in coatability and adhesivity.

The melt viscosity is measured using a TVB-15 series Brookfield model rotary viscometer (with M2 rotor) at 190° C. according to JIS K6862.

The resin composition preferably satisfies the following (1) and (2):

(1) The tensile modulus of elasticity at 23° C. is 1 MPa or more and 200 MPa or less.

(2) The breaking elongation at 23° C. is 50% or more and 2,000% or less.

### (Tensile Modulus of Elasticity)

From the viewpoint of followability of the hot-melt adhesive to an adherend, from the viewpoint of adhesivity to the rough surface of an adherend, and from the viewpoint of the anchor effect to the rough surface of an adherend, the resin composition preferably has an appropriate softness. From these viewpoints, the tensile modulus of elasticity at 23° C. of the resin composition is preferably 1 MPa or more and 200 MPa or less, more preferably 1 MPa or more and 150 MPa or less, even more preferably 1 MPa or more and 100 MPa or less.

### (Breaking Elongation)

From the viewpoint of the adhesion strength to an adherend, and for the purpose of making the hot-melt adhesive closely adhere to the rough surface of an adherend, it is desirable that the resin composition is suitably soft and has followability to deformation. From this viewpoint, the breaking elongation at 23° C. of the resin composition is preferably 100% or more, more preferably 300% or more, even more preferably 500% or more, further more preferably 600% or more, further more preferably 700% or more.

### <Method for Measurement of Tensile Modulus of Elasticity and Breaking Elongation>

The resin composition is sandwiched between two PET films (trade name: Lumirror S10, thickness 50 μm, by Toray Corporation) via a spacer having a thickness of 1 mm therebetween, and molded by pressing to give a sheet. This was stored at room temperature for about 1 day to stabilize the condition, and then a test piece was formed of it. This was tested under the following conditions according to JIS K7113 to measure the tensile modulus of elasticity and the breaking elongation thereof.
Test piece (No. 2 dumbbell) thickness: 1 mm
Cross head speed: 100 mm/min
Load cell: 100 N
Measurement temperature: 23° C.

### (Storage Elastic Modulus at 25° C.)

The resin composition has a storage elastic modulus (E′) at 25° C. obtained from the solid viscoelasticity measurement of the composition of preferably 1 MPa or more and 200 MPa or less. A higher elastic modulus indicates a harder material. When the storage elastic modulus E′ at 25° C. (around room temperature) is too low, retentivity is poor, while on the other hand, when the storage elastic modulus is too high, adhesivity and tackiness are poor.

From this point of view, the storage elastic modulus at 25° C. is preferably 1 MPa or more and 100 MPa or less, more preferably 1 MPa or more and 80 MPa or less.

### (Storage Elastic Modulus at 50° C.)

The resin composition has a storage elastic modulus (E′) at 50° C. obtained from the solid viscoelasticity measurement of the composition of 1 MPa or more and 100 MPa or less. When the storage elastic modulus E′ at 50° C. (high temperature) is too low, retentivity at high temperatures is poor, while on the other hand, when the storage elastic modulus is too high, pressure-sensitive adhesivity and tackiness are poor. Here, 50° C. is a temperature which the resin composition should withstand as a pressure-sensitive adhesive tape, and the resin composition is required to be moderately soft at this temperature.

From this point of view, the storage elastic modulus at 50° C. is preferably 1 MPa or more and 80 MPa or less, more preferably 1 MPa or more and 60 MPa or less.

Ideally, it is preferred that the storage elastic modulus at 25° C. is comparable to the storage elastic modulus at 50° C., and the storage elastic modulus does not vary in any temperature range.

The storage elastic modulus can be determined through the following solid viscoelasticity measurement.

The measurement is carried out in a nitrogen atmosphere under the following conditions using a viscoelasticity measuring device (manufactured by SII Nano Technology, Inc., trade name: DMS 6100 (EXSTAR 6000)).

### (Measurement Conditions)

Measurement mode: tensile mode

Measurement temperature: −150° C. to 230° C.

Temperature rising rate: 5° C./min

Measurement frequency: 1 Hz

Sample size: length: 10 mm, width: 4 mm, thickness: 1 mm (press-molded product)

### (Use of Resin Composition)

The above-mentioned resin composition and the resin composition obtained by the method of the present invention have high flowability and are expected to be excellent in coatability and pressure-sensitive adhesivity, and therefore are favorably used, for example, for hot-melt adhesives and pressure-sensitive adhesive tapes for hygienic materials, packaging, book-making, fibers, woodwork, electric materials, can-making, construction, filters, low-pressure molding and bag-making.

The resin composition exerts mostly the advantageous effects of the present invention especially when used for hot-melt adhesives, and is also favorably used as pressure-sensitive adhesive tapes in the manner as follows.

The pressure-sensitive adhesive tape uses the resin composition in the adhesive layer, and the resin composition can be directly applied to a support, or can be applied to an auxiliary support and transferred onto a final support from it. The material of the support is not particularly limited, but for example, a fabric, a knit, a scrim, a nonwoven fabric, a laminate, a net, a film, a paper, a tissue paper, a foamed body, or a foamed film can be used. Examples of the film include polypropylene, polyethylene, polybutene, oriented polyester, hard PVC and soft PVC, a polyolefin foamed body, a polyurethane foamed body, EPDM, and a chloroprene foamed body.

The support can be prepared by a chemical pretreatment with a priming coat or a physical pretreatment with corona discharge before it is fitted with the resin composition. The rear surface of the support can be subjected to an anti-adhesive physical treatment or coating.

The resin composition is also favorably used for adhesion of polyolefinic materials, and is used, for example, for adhesion between polyolefin nonwoven fabric-polyolefin nonwoven fabric, adhesion between polyolefin film-polyolefin nonwoven fabric, and is favorably used for adhesion between PP nonwoven fabric-PP nonwoven fabric or adhesion between PE film-PP nonwoven fabric.

The above-mentioned resin composition and the resin composition obtained by the method of the present invention have high flowability and are expected to be excellent in processability, and therefore are favorably used, for example, as raw materials for molded articles.

### [Hot-Melt Adhesive, and Method for Reducing Viscosity in Melt of Hot-Melt Adhesive and Imparting Elongation Characteristics to Hot-Melt Adhesive]

Another embodiment of the present invention is a method of reducing the viscosity in melt of the hot-melt adhesive containing a thermoplastic resin, using the above-mentioned plasticizer for resins, and imparting elongation characteristics to the hot-melt adhesive.

The hot-melt adhesive is preferably one using the above-mentioned resin composition.

Accordingly, the thermoplastic resin for use in the hot-melt adhesive is preferably the thermoplastic resin described in the section of the above <Resin Composition>, more preferably a polyolefinic resin.

The hot-melt adhesive is preferably one using a resin composition that contains an amorphous propylenic polymer (AA) having a weight-average molecular weight (Mw), measured according to a GPC method, of 5,000 to 30,000 and having a molecular weight distribution (Mw/Mn) of 3.0 or less, and a polyolefinic polymer (BB) having a melting point of 20° C. or higher and 160° C. or lower and ΔH of 5 J/g or more and 100 J/g or less.

Further, the hot-melt adhesive can further contain a tackifier, and can contain a solvent, and can contain various additives in addition to the above-mentioned components, within a range not interfering with the advantageous effects of the present invention.

The content of the plasticizer for resins in the hot-melt adhesive is, from the viewpoint of the balance of pressure-sensitive adhesivity, tackiness and retentivity, preferably 5% by mass or more and 95% by mass or less, more preferably 10% by mass or more and 90% by mass or less, even more preferably 15% by mass or more and 85% by mass or less, further more preferably 20% by mass or more and 80% by mass or less.

In particular, when the hot-melt adhesive is used for hygienic materials, the content of the plasticizer for resins in the hot-melt adhesive is preferably 50% by mass or less, more preferably 40% by mass or less, even more preferably 30% by mass or less. The lower limit is preferably 5% by mass or more, more preferably 10% by mass or more.

The content of the amorphous propylenic polymer in the hot-melt adhesive is, from the viewpoint of the balance of pressure-sensitive adhesivity, tackiness and retentivity, preferably 5% by mass or more and 95% by mass or less, more preferably 10% by mass or more and 90% by mass or less, even more preferably 15% by mass or more and 85% by mass or less, further more preferably 20% by mass or more and 80% by mass or less.

The content of the thermoplastic resin or the polyolefinic polymer (BB) in the hot-melt adhesive is, from the viewpoint of pressure-sensitive adhesivity and tackiness expressibility, preferably 5% by mass or more and 95% by mass or less, more preferably 10% by mass or more and 90% by mass or less, even more preferably 15% by mass or more and 85% by mass or less, further more preferably 20% by mass or more and 80% by mass or less.

As in the above, when the plasticizer for resins of the present invention is targeted to use in a hot-melt adhesive, the plasticizer for resins, preferably the amorphous propylenic polymer can be used in the thermoplastic resin-containing hot-melt adhesive for the purpose of reducing the viscosity in melt of the hot-melt adhesive and imparting elongation characteristics thereto.

Specific use of the hot-melt adhesive is described below.

### (Hot-Melt Adhesive for Hygienic Materials)

The hot-melt adhesive can be favorably used, for example, for adhesion of nonwoven fabrics constituting hygienic articles and/or adhesion of a plastic film and a nonwoven fabric constituting hygienic articles.

The hygienic article is preferably a nonwoven article, more precisely including a tape-type or pants-type diaper, a pantyliner, and a sanitary napkin, preferably a pants-type diaper and a pantyliner.

### (Hot-Melt Adhesive for Packaging and Woodwork)

According to the present invention, there can be obtained a hot-melt adhesive having high flowability and excellent in coatability, and therefore the hot-melt adhesive can be favorably used as an adhesive for packaging materials such as cardboards or as a hot-melt adhesive for woodwork.

The adhesion method in woodwork includes a step of melting a hot-melt adhesive, applying it to a woodwork substrate or any other substrate, and adhering a woodwork substrate or any other substrate thereto. In this, at least one kind of the substrates to be used is a substrate for woodwork.

Here, the woodwork substrate is not specifically limited and may be any material for woodwork, for example, including various kinds of wood materials such as middle density fiber boards (MDF), high density fiber boards (HDF) and pine materials, paper produced from pulp and others, flush panels, laminated lumbers, veneers, decorative laminates, plywoods, and products formed of wood, and not limited thereto, further including at least one selected from materials derived from various plants (for example, cellulose skeletons such as abaca, banana or sugar cane used as pulp to be a raw material for paper (or those derived from natural materials having a skeleton similar thereto)), and materials using them as a part or a whole, and the surface to be adhered with the hot-melt adhesive for woodwork is composed of one for use for woodwork.

Also according to the present invention, there can be obtained a hot-melt adhesive having high flowability and excellent in coatability, and therefore the hot-melt adhesive can be favorably used in a molding method for low-pressure molding. Accordingly, the other substrate to which the hot-melt adhesive is applied includes, though not specifically limited thereto, plastic materials and metal materials for use for the above-mentioned various materials.

### EXAMPLES

Next, the present invention will be more specifically described with reference to Examples, but the present invention is by no means limited thereto.

### Synthesis Example 1

### Synthesis of Complex A ((1,1′-ethylene)(2,2′-tetramethyldisilylene)bisindenylzirconium dichloride)

According to the description of Synthesis Example 1 of JP6263125B, (1,1′-ethylene)(2,2′-tetramethyldisilylene)bisindenylzirconium dichloride represented by the formula (1) was synthesized.

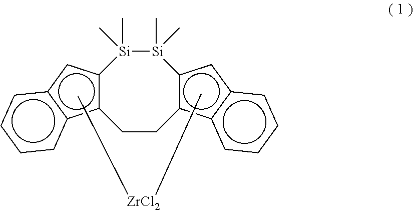

### Synthesis Example 2

### Synthesis of complex B ((1,2′-diphenylsilylene) (2′,1-diphenylsilylene)bis(3-trimethylsilylmethylindenyl)zirconium dichloride)

According to the description of Production Example 12 of WO2018/164161, (1,2′-diphenylsilylene) (2′,1-diphenylsilylene)bis(3-trimethylsilylmethylindenyl)zirconium dichloride was synthesized.

### Synthesis Example 3

### Synthesis of Complex C ((1,2′-dimethylsilylene)(2,1′-dimethylsilylene)-bis(3-trimethylsilylmethylindenyl)zirconium dichloride)

(1,2′-Dimethylsilylene) (2,1′-dimethylsilylene)-bis(3-trimethylsilylmethylindenyl)zirconium dichloride) was synthesized according to the description of Reference Example 1 of JP4053993B.

### [Production of Plasticizer for Resins]

### Production Example 1

### (Production of Amorphous Propylenic Polymer (A-1))

Heptane (400 mL), triisobutylaluminum (2 M, 0.2 mL, 0.4 mmol), N,N-dimethylanilinium tetrakis(pentafluorophenyl)borate heptane slurry (10 μmol/mL, 0.3 mL, 3.0 μmol), and the complex A (10 μmol/mL, 0.10 mL, 1.0 μmol) were put into a one-liter autoclave that had been dried by heating, and further, 0.1 MPa of hydrogen was introduced thereinto. With stirring, propylene was charged thereinto and pressurized up to a total pressure of 0.8 MPa, and polymerized at a temperature of 85° C. for 60 minutes. After completion of the polymerization reaction, propylene and hydrogen were depressurized, the polymerization liquid was heated and dried under reduced pressure to produce 105 g of amorphous propylenic polymer (A-1) which is an amorphous propylenic homopolymer.

### Production Example 2

### (Production of Amorphous Propylenic Polymer (A-2))

N-heptane (20 L/hr), triisobutylaluminum (15 mmol/hr), and further a catalyst component produced by previously contacting dimethylanilinium tetrakispentafluorophenylborate, the complex B obtained in Synthesis Example 2, triisobutylaluminum and propylene in a ratio by mass of 1/1/2/20 were continuously supplied to a 20-L stainless reactor equipped with a stirrer, at 30 μmol/hr in terms of zirconium. Propylene and hydrogen were continuously supplied thereinto so as to keep the total pressure inside the reactor at 1.0 MPa G, and with appropriately controlling the ratio of propylene and hydrogen at around a polymerization temperature of 70° C., a polymerization solution was obtained. The resultant polymerization solution was heated and dried under reduced pressure to obtain an amorphous propylenic polymer (A-2).

### [Production of Thermoplastic Resin]

### Production Example 3

### (Production of Polyolefinic Polymer (B-1))

N-heptane (20 L/hr), triisobutylaluminum (15 mmol/hr), and further a catalyst component produced by previously contacting the complex C obtained in Production Example 3, dimethylanilinium tetrakispentafluorophenylborate and triisobutylaluminum in a ratio by mass of 1/2/20 with propylene were continuously supplied to a 20-L stainless reactor equipped with a stirrer, at 6 μmol/hr in terms of zirconium.

Propylene and hydrogen were continuously supplied thereinto so as to keep the vapor phase hydrogen concentration at 8 mol % and the total pressure inside the reactor at 1.0 MPa·G at a polymerization temperature of 65° C. An antioxidant was added to the resultant polymerization solution so that the content thereof could be 1,000 ppm by mass, and then the solvent, n-heptane was removed to obtain a polyolefinic polymer (B-1).

### [Meso pentad fraction [mmmm], racemic pentad fraction [rrrr], 1,3-bond fraction and 2,1-bond fraction (¹³C-NMR measurement)]

The above amorphous propylenic polymer (A-1) and amorphous propylenic polymer (A-2) were analyzed by ¹³C-NMR measurement using the following apparatus under the following conditions to determine the meso pentad fraction [mmmm], the racemic pentad fraction [rrrr], the 1,3-bond fraction and the 2,1-bond fraction thereof according to the above-mentioned method.

Apparatus: JNM-EX400 series ¹³C-NMR apparatus by JEOL Corporation.

Method: proton complete decoupling method

Concentration: 230 mg/mL

Solvent: mixed solvent of 1,2,4-trichlorobenzene and deuterated benzene at 90:10 (volume ratio)

Temperature: 130° C.

Pulse width: 45°

Pulse repetition time: 4 seconds

Accumulation: 10,000 times

### [Glass Transition Temperature (Tg) and Melting Point (Tm) (DSC Measurement)]

The glass transition temperature (Tg) of the above amorphous propylenic polymer (A-1) and amorphous propylenic polymer (A-2), and the melting point (Tm) of the above amorphous propylenic polymer (A-1), amorphous propylenic polymer (A-2) and polyolefinic polymer (B-1) were determined as follows, using a differential scanning calorimeter (trade name: DSC-7, by PerkinElmer Co., Ltd.).

10 mg of the sample was heated up to 150° C. at 10° C./min in a nitrogen atmosphere, then cooled down to −75° C., kept as such for 5 minutes, and again heated up to 150° C., and on the resultant melting endothermic curve in the 2nd heating, the glass transition temperature (Tg) was read. The method of determining the glass transition temperature (Tg) is described in detail. On the resultant melting endothermic curve, at the site at which the endothermic curve changed first toward the endothermic direction, the temperature corresponding to the position at which the extended line from the original base line intersects the tangent line drawn to the inflection point on the curve that connects the original base line and the shifted base line (the point at which the upwardly convex curve changes to the downwardly convex curve) is read, and is referred to as a glass transition temperature Tg. In the case where the sample has a melting point, the peak top observed on the highest temperature side of the melting endothermic curve is referred to as a melting point Tm (° C.).

### [Weight-Average Molecular Weight (Mw) and Molecular Weight Distribution (Mw/Mn) (GPC Measurement]

The weight-average molecular weight (Mw) of the above amorphous propylenic polymer (A-1), amorphous propylenic polymer (A-2) and polyolefinic polymer (B-1), and the molecular weight distribution (Mw/Mn) of the above amorphous propylenic polymer (A-1) and amorphous propylenic polymer (A-2) were determined according to a gel permeation chromatography (GPC) method. For the measurement, the following apparatus was used under the following conditions, and the molecular weight was determined as a polystyrene-equivalent molecular weight.

### <GPC Measurement Apparatus>

Device: “HLC8321GPC/HT” by Tosoh Corporation

Detector: RI detector

Column: “TOSOH GMHHR—H(S)HT” by Tosoh Corporation x 2

### <Measurement Conditions>

Solvent: 1,2,4-trichlorobenzene
Measurement Temperature: 145° C.
Flow Rate: 1.0 mL/min
Sample Concentration:0.5 mg/mL
Injection Amount: 300 pia
Calibration Curve: Prepared using a PS standard substance.
Molecular Amount Conversion: Calculated using a universal calibration method.
Analysis Program: 8321GPC-WS
   [Melt viscosity]

The melt viscosity at 190° C. of the above amorphous propylenic polymer (A-1), amorphous propylenic polymer (A-2) and polyolefinic polymer (B-1) was measured using a TVB-15 series Brookfield model rotary viscometer (with M2 rotor) according to JIS K-6862.

### [Melting Endothermic Amount]

Using a differential scanning calorimeter (DSC), a sample, thermoplastic resin was, after left at −40° C. in a nitrogen atmosphere for 5 minutes, heated at 10° C./min, and on the resultant melting endothermic curve, a line drawn by connecting the point with no heat quantity change on the low-temperature side of the peak and the point with no heat quantity change on the high-temperature side of the peak was taken as a base line and the area surrounded by the peaks and the base line was measured, and this is the melting endothermic amount (ΔH).

The measurement results of the physical properties of the amorphous propylenic polymer (A-1) and the amorphous propylenic polymer (A-2) determined according to the above-mentioned measurement methods are shown in Table 1.

TABLE 1

| | | Amorphous | Amorphous |
|---|---|---|---|
| | | Propylenic | Propylenic |
| | | Polymer | Polymer |
| Item | Unit | (A-1) | (A-2) |
| Meso pentad fraction | mol % | 6.1 | 8.6 |
| [mmmm] | | | |
| Racemic pentad fraction | mol % | 7.0 | 8.2 |
| [rrrr] | | | |
| 1,3-Bond fraction | mol % | less than 0.1 | less than 0.1 |
| 2,1-Bond fraction | mol % | less than 0.1 | less than 0.1 |
| Melting point (Tm) | ° C. | not detected | not detected |
| Glass transition | ° C. | −9 | −4 |
| temperature (Tg) | | | |
| Weight-average molecular | — | 17000 | 45000 |
| weight (Mw) | | | |
| Molecular weight | — | 2 | 2 |
| distribution (Mw/Mn) | | | |
| 190° C. Melt viscosity | mPa · s | 170 | 9900 |

Also the measurement results of the physical properties of the polyolefinic polymer (B-1) determined according to the above-mentioned measurement methods are shown in Table 2.

TABLE 2

| | | Polyolefinic |
|---|---|---|
| Item | Unit | Polymer (B-1) |
| Melting endothermic amount (ΔH) | J/g | 36 |
| Melting point (Tm) | ° C. | 71 |
| Weight-average molecular weight (Mw) | — | 44000 |
| 190° C. melt viscosity | mPa · s | 8500 |

Using the amorphous propylenic polymer (A-1) and the amorphous propylenic polymer (A-2) shown in Table 1 and the polyolefinic polymer (B-1) shown in Table 2, and also the following raw materials, the resin composition of the following Examples and Comparative Examples were produced.

### <Thermoplastic Resin>

Propylene homopolymer (trade name: Novatec PP SA03, by Japan Polypropylene Corporation)

Ethylene/propylene/1-butene copolymer (trade name: Vestoplast 308, by Evonik Industries AG, content of ethylene derived structural unit=30 mol %, content of propylene-derived structural unit=23 mol %, content of 1-butene-derived structural unit=47 mol %, weight-average molecular weight Mw=56,600, Mw/Mn=5.7, penetration=17)

Propylene/1-butene copolymer (trade name: REXtac 2880, by LLC Corporation, penetration=8)

### <Tackifier (Tackifying Resin)>

Hydrogenated derivative of aliphatic hydrocarbon petroleum resin (trade name: Escorez 5300, by ExxonMobil Chemical Corporation)

### <Oil>

Paraffinic process oil (trade name: Diana Process Oil PW-90, by Idemitsu Kosan Co., Ltd.)

### Example 1

### (Production of Resin Composition)

30 g of the amorphous propylenic polymer (A-1) produced in Production Example 1 and 30 g of the polyolefinic polymer (B-1) were put into a 140-mL sample bottle, and melted by heating at 180° C. for 30 minutes, and then fully mixed and stirred with a metal spoon to obtain a resin composition.

### Example 2

### (Production of Resin Composition)

A resin composition was obtained in the same manner as in Example 1, except that the blending amount of the polyolefinic polymer was 42 g and the blending amount of the amorphous propylenic polymer (A-1) was 18 g.

### Comparative Example 1

### (Production of Resin Composition)

A resin composition was obtained in the same manner as in Example 1, except that, in Example 1, process oil PW-90 was used in place of the amorphous propylenic polymer (A-1), the blending amount of the polyolefinic polymer (B-1) was 42 g and the blending amount of PW-90 was 18 g.

### Comparative Example 2

### (Production of Resin Composition)

A resin composition was obtained in the same manner as in Example 1, except that, in Example 1, the amorphous propylenic polymer (A-2) was used in place of the amorphous propylenic polymer (A-1).

### Example 3

### (Production of Resin Composition)

A resin composition was obtained in the same manner as in Example 1, except that the blending amount of the polyolefinic polymer (B-1) was 21 g, the blending amount of the amorphous propylenic polymer (A-1) was 21 g, and 18 g of a tackifying resin, Escorez 5300 was added.

### Comparative Example 3

### (Production of Resin Composition)

A resin composition was obtained in the same manner as in Example 3, except that, in Example 2, 12.6 g of process oil PW-90 was added in place of the amorphous propylenic resin (A-1) and the blending amount of the amorphous propylenic polymer (A-2) was 29.4 g.

### [Melt Viscosity]

The melt viscosity at 190° C. of the resin compositions obtained in Examples 1 to 3 and Comparative Examples 1 to 3 was measured using a TVB-15 series Brookfield model rotary viscometer (with M2 rotor) according to JIS K6862. The results are shown in Table 3. As Comparative Example 4, the results of the polyolefinic polymer (B-1) are also shown in Table 3.

### [Storage Elastic Modulus]

The resin composition obtained in Examples 1 to 3 and Comparative Examples 1 to 3 was melted, sandwiched between PET films (trade name: Lumirror S10, thickness 50 μm, by Toray Industries Inc.) via a stainless spacer having a thickness of 1 mm therebetween, and molded by pressing at 140° C. to give a sheet having a thickness of approximately 1 mm. This was stored at room temperature for one day to stabilize the condition, and then a test piece for solid viscoelasticity measurement was formed. This was tested under the following conditions to measure the solid viscoelasticity to thereby determine the storage elastic modulus. The results are shown in Table 3. As Comparative Example 4, the results of the polyolefinic polymer (B-1) are also shown in Table 3.

### <Measurement Conditions>

Using a viscoelasticity measurement apparatus (trade name: DMS 600 (EXSTAR 6000) BY SII NanoTechnology Inc.), the measurement was carried out in a nitrogen atmosphere.

Measurement mode: tensile mode

Measurement temperature: In a range of −150° C. to 230° C., E′ at 25° C. was measured.

Temperature rising rate: 5° C./min

Measurement frequency: 1 Hz

Sample size: length: 10 mm, width: 4 mm, thickness: 1 mm (press-molded product)

### [Tensile Modulus of Elasticity and Breaking Elongation]

The resin composition obtained in Examples 1 to 3 and Comparative Examples 1 to 3 was melted, sandwiched between PET films (trade name: Lumirror S10, thickness 50 μm, by Toray Industries Inc.) via a stainless spacer having a thickness of 1 mm therebetween, and molded by pressing at 140° C. to give a sheet having a thickness of approximately 1 mm. This was stored at room temperature for one day to stabilize the condition, and then a test piece for measurement of tensile modulus of elasticity and breaking elongation was formed. According to JIS K7113, this was tested under the following conditions to measure the tensile modulus of elasticity and the breaking elongation. As Comparative Example 4, the results of the polyolefinic polymer (B-1) are also shown in Table 3.

### <Measurement Conditions>

Test piece (No. 2 dumbbell) thickness: 1 mm
Cross head speed: 100 mm/min
Load cell: 100 N
Measurement temperature: 23° C.

### [Adhesion Force (T-Peel Test Force)]

The resin composition obtained in Examples 1 to 2 and Comparative Examples 1 to 2 was melted, sandwiched between PET films (trade name: Lumirror S10, thickness 50 μm, by Toray Industries Inc.) via a stainless spacer having a thickness of 1 mm therebetween, and molded by pressing at 140° C. to give a sheet having a thickness of approximately 1 mm. The resultant sheet was cut into a piece having a width of 2 cm and a length of 15 cm to be a test piece. According to JIS K6854-1, T-peel test was carried out using a tensile tester. At that time, an average value of the measured value in a length of 10 cm from 2 cm to 12 cm of the test piece was determined as a T-peel test force. The results are show in Table 2. As Comparative Example 4, the results of the polyolefinic polymer (B-1) are also shown in Table 3.

TABLE 3

| | | | | | Comparative | Comparative | | Comparative | Comparative |
|---|---|---|---|---|---|---|---|---|---|
| | | | Example 1 | Example 2 | Example 1 | Example 2 | Example 3 | Example 3 | Example 4 |
| Formulation | Plasticizer for resins | Polymer (A-1) (g) | 30 | 18 | — | — | 21 | — | — |
| of Resin | (amorphous | (Mw 17,000) | | | | | | | |
| Composition | propylenic polymer) | Polymer (A-2) (g) | — | — | — | 30 | — | — | — |
| | | (Mw 45,000) | | | | | | | |
| | Thermoplastic resin | Polymer (B-1) (g) | 30 | 42 | 42 | 30 | 21 | 29.4 | 60 |
| | (polyolefinic | | | | | | | | |
| | polymer) | | | | | | | | |
| | Tackifier | Escorez 5300 (g) | — | — | — | — | 18 | 18 | — |
| | Oil | PW-90 (g) | — | — | 18 | — | — | 12.6 | — |
| Physical | 190° C. Melt | mPa · s | 1600 | 3200 | 1700 | 9100 | 980 | 1000 | 8500 |
| Properties and | viscosity | | | | | | | | |
| Evaluation | 25° C. Storage | MPa | 17 | — | 23 | 24 | 9 | 12 | 108 |
| of Resin | elastic modulus E′ | | | | | | | | |
| Composition | Tensile modulus | MPa | 12 | 31 | 19 | 19 | 8 | 8 | 85 |
| | of elasticity | | | | | | | | |
| | Breaking elongation | % | 110 | 610 | 30 | 400 | 710 | 80 | 630 |
| | Adhesion force (T- | N | 4.38 | 0.81 | 0.05 | 2.74 | — | — | 0.14 |
| | peel test force) | | | | | | | | |

The resin compositions of Example 1 and 2 containing the plasticizer for resins of the present invention and a thermoplastic resin have an effect of reducing the melt viscosity, the tensile modulus of elasticity and the storage elastic modulus, and are extremely excellent in breaking elongation as compared with Comparative Example 1. From this, it is known that the amorphous propylenic polymer (A-1) exerts an excellent effect as a plasticizer for resins. On the other hand, it is known that the resin composition of Comparative Example 2 containing the amorphous propylenic polymer (A-2) not corresponding to the plasticizer for resins of the present invention could not reduce the viscosity in melt and could not attain the effect as a plasticizer for resins. Further, as known by comparing Example 3 and Comparative Example 3, even when a tackifier is added, the resin composition of Example 3 has good breaking elongation characteristics. From this, it is known that the plasticizer for resins of the present invention can have an effect of maintaining excellent elongation characteristics while having an excellent melt viscosity reducing effect.

Further, it is known that the resin compositions of Examples 1 and 2 are excellent in the adhesion force as compared with Comparative Example 1 using an oil and Comparative Example 4 not using a plasticizer. In addition, also as known by comparing Example 1 and Comparative Example 2, the plasticizer for resins of the present invention can increase adhesion force as compared with any other amorphous propylenic polymer.

### Example 4

### (Production of Resin Composition)

48 g of a thermoplastic resin, Novatec PP SA03, and 12 g of the amorphous propylenic polymer (A-1) were put into a 200-mL sample bottle, well mixed and stirred at 230° C. to obtain a resin composition.

### Comparative Example 5

### (Production of Resin Composition)

Using 54 g of a thermoplastic resin, Novatec PP SA03, and 6 g of an oil, Process Oil PW-90, a resin composition was obtained in the same manner as in Example 4.

### Comparative Example 6

### (Production of Resin Composition)

A resin composition was obtained in the same manner as in Example 4, except that, in Example 4, the amorphous propylenic polymer (A-1) was changed to Process Oil PW-90.

### Comparative Example 7

The thermoplastic resin, Novatec PP SA03 used in Example 4 was evaluated as Comparative Example 7.

### [Tensile Modulus of Elasticity and Breaking Elongation]

The resin composition obtained in Example 4 and Comparative Examples 5 and 6 as well as Novatec PP SA03 (Comparative Example 7) was melted, sandwiched between PET films (trade name: Lumirror S10, thickness 50 μm, by Toray Industries Inc.) via a stainless spacer having a thickness of 1 mm therebetween, and molded by pressing at 200° C. to give a sheet having a thickness of approximately 1 mm. This was stored at room temperature for one day to stabilize the condition, and then a test piece for measurement of tensile modulus of elasticity and breaking elongation as well as a test piece for transparency conformation was formed. According to JIS K7113, this was tested under the following conditions to measure the tensile modulus of elasticity and the breaking elongation.

### <Measurement Conditions>

Test piece (No. 2 dumbbell) thickness: 1 mm
Cross head speed: 100 mm/min
Load cell: 100 N
Measurement temperature: 23° C.

### [Transparency]

On a white copy paper printed with black alphabet letters each having a size of 5 mm×5 mm, the sheet having a thickness of approximately 1 mm obtained according to the method described in the above [Tensile modulus of elasticity and breaking elongation] (resin composition obtained in Example 4 and Comparative Examples 5 and 6, Novatec PP SA03 (Comparative Example 7)) was put, and the transparency thereof was evaluated by visual inspection under the following criteria.

A: Even the outline of the letter was definitely recognized (transparent).

B: The outline of the letter was indefinite, but the letter can be read (somewhat transparent).

C: The letter could not be read (cloudy).

TABLE 4

| | | | | Comparative | Comparative | Comparative |
|---|---|---|---|---|---|---|
| | | | Example 4 | Example 5 | Example 6 | Example 7 |
| Formulation | Plasticizer for resins | Polymer (A-1) (g) | 12 | — | — | — |
| of Resin | (amorphous | (Mw 17,000) | | | | |
| Composition | propylenic polymer) | | | | | |
| | Thermoplastic resin | Novatec PP | 48 | 54 | 48 | 60 |
| | (polyolefinic | SA03 (g) | | | | |
| | polymer) | | | | | |
| | Oil | PW-90 (g) | — | 6 | 12 | — |
| Physical | Tensile modulus | MPa | 620 | 850 | 400 | 1500 |
| Properties and | of elasticity | | | | | |
| Evaluation | Breaking elongation | % | 350 | 10 | 3 | 7 |
| of Resin | transparency | — | A | C | C | B |
| Composition | | | | | | |

It is known that the resin composition of Example 4 containing the amorphous propylenic polymer (A-1) can greatly lower the tensile modulus of elasticity as compared with Comparative Example 7 not blended with a plasticizer. From this, it is known that the amorphous propylenic polymer (A-1) in the present invention has a sufficient effect as a plasticizer for resins. Further as known by comparison with Examples 5 and 6 using an oil, the resin composition of Example 4 is known to have good breaking elongation characteristics and high transparency.

From these, it is known that the plasticizer for resins of the present invention can impart excellent elongation characteristics and transparency while having an excellent effect as a plasticizer for resins.

### Example 5

### (Production of Resin Composition)

48 g of a thermoplastic resin Vestoplast 308 and 12 g of the amorphous propylenic polymer (A-1) were put into a 200-mL sample bottle, and well mixed and stirred at 230° C. to obtain a resin composition.

### Comparative Example 8

### (Production of Resin Composition)

Using 54 g of a thermoplastic resin Vestoplast 308 and 6 g of an oil, Process Oil PW-90, a resin composition was obtained in the same manner as in Example 5.

### Comparative Example 9

A thermoplastic resin Vestoplast 308 used in Example 5 was evaluated as Comparative Example 9.

### Example 6

### (Production of Resin Composition)

48 g of a thermoplastic resin REXtac 2880 and 12 g of the amorphous propylenic polymer (A-1) were put into a 200-mL sample bottle, and well mixed and stirred at 230° C. to obtain a resin composition.

### Comparative Example 10

### (Production of Resin Composition)

Using 54 g of a thermoplastic resin REXtac 2880 and 6 g of an oil, Process Oil PW-90, a resin composition was produced in the same manner as in Example 5.

### Comparative Example 11

A thermoplastic resin REXtac 2880 used in Example 6 was evaluated as Comparative Example 11.

In the same manner as in Examples 1 to 3 and Comparative Examples 1 to 4, the melt viscosity, the storage elastic modulus, the tensile modulus of elasticity, the breaking elongation and the adhesion force (T-peel test force) of the resin compositions and the thermoplastic resins of Examples 5 to 6 and Comparative Examples 8 to 11 were evaluated. The evaluation methods are as mentioned above.

TABLE 5

| | | | | Comparative | Comparative | | Comparative | Comparative |
|---|---|---|---|---|---|---|---|---|
| | | | Example 5 | Example 8 | Example 9 | Example 6 | Example 10 | Example 11 |
| Formulation | Plasticizer for resins | Polymer (A-1) (g) | 12 | — | — | 12 | — | — |
| of Resin | (amorphous | (Mw 17,000) | | | | | | |
| Composition | propylenic polymer) | | | | | | | |
| | Thermoplastic resin | Vestoplast 308 | 48 | 54 | 60 | — | — | — |
| | (polyolefinic | Rextac 2880 | — | — | — | 48 | 54 | 60 |
| | polymer) | | | | | | | |
| | Oil | PW-90 (g) | — | 6 | — | — | 6 | — |
| Physical | 190° C. Melt | mPa · s | 4600 | 5200 | 9300 | 4200 | 4700 | 8200 |
| Properties and | viscosity | | | | | | | |
| Evaluation | 25° C. Storage | MPa | 18 | — | 31 | 73 | — | 139 |
| of Resin | elastic modulus E′ | | | | | | | |
| Composition | Tensile modulus | MPa | 13 | 11 | 29 | 45 | 51 | 86 |
| | of elasticity | | | | | | | |
| | Breaking elongation | % | 310 | 250 | 290 | 340 | 340 | 390 |
| | Adhesion force (T- | N | 6.87 | 5.57 | 4.50 | 0.60 | 0.07 | 0.05 |
| | peel test force) | | | | | | | |

In general, thermoplastic resins having various properties are used depending on use. As known from Table 5, the plasticizer for resins of the present invention is, even when various copolymers are used as a thermoplastic resin for the base polymer, able to exert an effect of reducing the melt viscosity, the tensile modulus of elasticity, and a storage elastic modulus and is able to improve breaking elongation. From this, it is known that the amorphous propylenic polymer (A-1) is excellent as a resin plasticizer for thermoplastic resins having various properties.

Further, as known from the results of Examples 5 and 6, the plasticizer for resins of the present invention is, even when various copolymers are used as a thermoplastic resin for the base polymer, able to exert a high effect of increasing adhesion force.

1. A plasticizer suitable for one or more resins, comprising:
an amorphous propylenic polymer having a weight-average molecular weight (Mw), measured by GPC, in a range of from 5,000 to 30,000 and having a molecular weight distribution (Mw/Mn) of 3.0 or less.

2. The plasticizer of claim 1,
wherein the amorphous propylenic polymer is a propylene homopolymer.

3. The plasticizer of claim 1, wherein the amorphous propylenic polymer satisfies (a) and (b):
(a) a meso pentad fraction [mmmm], determined by DC-nuclear magnetic resonance, is less than 20 mol. %, and a racemic pentad fraction [rrrr] is less than 25 mol. %; and
(b) a 1,3-bond fraction, determined by DC-nuclear magnetic resonance, is less than 0.3 mol %, and a 2,1-bond fraction is less than 0.3 mol %.

4. The plasticizer of claim 1, wherein the amorphous propylenic polymer following (c) and (d):
(c) a glass transition temperature, measured with a differential scanning calorimeter (DSC), is −15° C. or higher; and,
(d) a melt viscosity at 190° C. is 1,000 mPa·s or less.

5. The plasticizer of claim 1, wherein a number of terminal unsaturated groups per one molecule of the amorphous propylenic polymer is less than 0.5.

6. A method of reducing viscosity in melt of a resin composition comprising a thermoplastic resin and imparting one or more elongation characteristics to the resin composition, the method comprising:
including in the resin composition the plasticizer of claim 1.

7. The method of claim 6, wherein the thermoplastic resin is a polyolefinic resin.

8. The method of claim 6, wherein the amorphous propylenic polymer is present in the resin composition is in a range of from 5 to 95% by mass.

9. The method of claim 6, wherein the resin composition further comprises a tackifier.

10. A method of reducing viscosity in melt of a hot-melt adhesive comprising a thermoplastic resin and imparting one or more elongation characteristics to the hot-melt adhesive, the method comprising:
including in the hot-melt adhesive the plasticizer of claim 1.

11. The method of claim 10, wherein the thermoplastic resin is a polyolefinic resin.

12. The method of claim 10, wherein an amorphous propylenic polymer is present in the hot-melt adhesive is 5 in a range of from 5 to 95% by mass.

13. The method of claim 10, wherein the hot-melt adhesive further comprises a tackifier.

14. An amorphous propylenic polymer satisfying (1) to (9):
(1) a weight-average molecular weight (Mw) in a range of from 5,000 to 30,000;
(2) a molecular weight distribution (Mw/Mn) of 3.0 or less;
(3) a meso pentad fraction [mmmm] less than 20 mol %;
(4) a racemic pentad fraction [rrrr] less than 25 mol %;
(5) a 1,3-bond fraction less than 0.3 mol. %;
(6) a 2,1-bond fraction less than 0.3 mol. %;
(7) glass transition temperature of −15° C. or higher;
(8) a melt viscosity at 190° C. of 1,000 mPa·s or less;
(9) a number of the terminal unsaturated groups per one molecule is less than 0.5.

15. The plasticizer of claim 1, wherein the amorphous propylenic polymer satisfies at least two of (a) to (d):
(a) a meso pentad fraction [mmmm], determined by DC-nuclear magnetic resonance, is less than 20 mol. %, and a racemic pentad fraction [rrrr] is less than 25 mol. %;
(b) a 1,3-bond fraction, determined by DC-nuclear magnetic resonance, is less than 0.3 mol. %, and a 2,1-bond fraction is less than 0.3 mol. %;
(c) a glass transition temperature, measured with a differential scanning calorimeter, is −15° C. or higher; and
(d) a melt viscosity at 190° C. is 1,000 mPa·s or less.

16. The plasticizer of claim 1, wherein the amorphous propylenic polymer satisfies at least three of (a) to (d):
(a) a meso pentad fraction [mmmm], determined by DC-nuclear magnetic resonance, is less than 20 mol. %, and a racemic pentad fraction [rrrr] is less than 25 mol. %;
(b) a 1,3-bond fraction, determined by DC-nuclear magnetic resonance, is less than 0.3 mol. %, and a 2,1-bond fraction is less than 0.3 mol. %;
(c) a glass transition temperature, measured with a differential scanning calorimeter, is −15° C. or higher; and
(d) a melt viscosity at 190° C. is 1,000 mPa·s or less.

17. The plasticizer of claim 1, wherein the amorphous propylenic polymer satisfies (a) to (d):
(a) a meso pentad fraction [mmmm], determined by DC-nuclear magnetic resonance, is less than 20 mol. %, and a racemic pentad fraction [rrrr] is less than 25 mol. %;
(b) a 1,3-bond fraction, determined by ¹³C-nuclear magnetic resonance, is less than 0.3 mol. %, and a 2,1-bond fraction is less than 0.3 mol. %;
(c) a glass transition temperature, measured with a differential scanning calorimeter, is −15° C. or higher; and
(d) a melt viscosity at 190° C. is 1,000 mPa·s or less.

18. The plasticizer of claim 1, wherein the amorphous propylenic polymer is a propylene homopolymer, and
wherein the amorphous propylenic polymer satisfies at least two of (a) to (d):
(a) a meso pentad fraction [mmmm], determined by ¹³C-nuclear magnetic resonance, is less than 20 mol. %, and a racemic pentad fraction [rrrr] is less than 25 mol. %;
(b) a 1,3-bond fraction, determined by ¹³C-nuclear magnetic resonance, is less than 0.3 mol. %, and a 2,1-bond fraction is less than 0.3 mol. %;
(c) a glass transition temperature, measured with a differential scanning calorimeter, is −15° C. or higher; and
(d) a melt viscosity at 190° C. is 1,000 mPa·s or less.
